(19) United States
(12) Patent Application Publication
(10) Pub. No.: US 2004/0215592 A1
(43) Pub. Date: Oct. 28, 2004

(54) Network system and agent server

(76) Inventors: Satoshi Matsuura, Kyoto (JP); Hiroshi Kutsumi, Osaka (JP); Takahiro Kudo, Osaka (JP); Nobuko Naitou, Hyogo (JP); Takayuki Hayami, Osaka (JP)

Correspondence Address: HARNESS, DICKEY & PIERCE, P.L.C., P.O. BOX 828, BLOOMFIELD HILLS, MI, 48303, US

(21) Appl. No.: 10/481,158

(22) PCT Filed: Jun. 20, 2002
(86) PCT No.: PCT/JP02/06193

(30) Foreign Application Priority Data
Jun. 20, 2001 (JP) 2001-186140

(51) Int. Cl. G06F 7/00

(52) U.S. Cl. 707/1

(57) ABSTRACT

In a network system providing a service, addition of an expanded function can be easily realized. A database server (105) provides a service such as accepting reservations of a facility to a terminal PC (101) via the Internet (104). To add an expanded function to the service provided by the database server (105), an agent server (106) executes a script, prepared by combining basic functions of the database server (105) and stored in a script storage section (209), according to a request from the terminal PC (101).

### BACKGROUND OF THE INVENTION

The present invention relates to technologies for a system providing a predetermined service via a network such as the Internet, including those for adding an expanded function to the service and providing a plurality of services in combination.

In recent years, with the widespread use of the Internet, services such as reserving a facility are available on the Web. Such a service is normally provided by constructing a Web page along with the nature of the service, to serve as a user interface in a system having a database and a Web server in combination.

Problems to be Solved

Services on the Web as described above have advantages such as permitting the user to make a reservation in real time while checking on a screen, and thus are highly convenient compared with services by telephone. However, a problem arises when it is attempted to expand a function of a presently available service, for example. That is, a replication of a presently operating system must be first prepared and then work for expansion of the function must be performed. This requires large cost and also takes much time and labor. Also, addition of a new function to a system presently stably operating is not so recommendable because this may give risks of causing instability in the behavior of the system and the like. In view of the above, a method enabling expansion of a function of an existing system easily without directly changing the system is desired.

### SUMMARY OF THE INVENTION

An object of the present invention is providing a network system providing a service in which addition of an expanded function can be easily realized.

The network system of the present invention includes: a database server for providing a predetermined service; and an agent server for emulating manipulation for the database server in response to a request received from a terminal, wherein the agent server includes a script storage section for storing a script prepared by combining basic functions of the database server, and the agent server adds an expanded function to the predetermined service by executing a script stored in the script storage section according to a request from the terminal.

According to the invention described above, to add an expanded function to a predetermined service provided by a database server, an agent server is installed for executing a script, prepared by combining basic functions of the database server, according to a request from a terminal. Therefore, no renewal of the functions of the database server itself is required, and thus the predetermined service can be expanded quite easily.

The database server preferably accepts reservations of a facility as the predetermined service.

Alternatively, the network system of the present invention includes: a database server for providing a predetermined service in response to manipulation from a first terminal; and an agent server for emulating manipulation for the database server in response to a request received from a second terminal different in type from the first terminal.

According to the invention described above, to make a predetermined service provided by a database server for a first terminal also available to a second terminal of a different type, an agent server is installed for emulating manipulation for the database server in response to a request received from the second terminal. Therefore, no renewal of the functions of the database server itself is required, and thus substantially the same service can be provided to a terminal of a different type quite easily.

Preferably, the first terminal is a personal computer and the second terminal is a TV set.

Alternatively, the network system of the present invention includes: a plurality of database servers for providing services different from each other; and an agent server for emulating manipulation for the plurality of database servers in response to a request received from a terminal, wherein the agent server includes a script storage section for storing a script prepared by combining basic functions of the plurality of database servers, and the agent server provides the plurality of services provided by the plurality of database servers in combination by executing a script stored in the script storage section according to a request from the terminal.

According to the invention described above, to provide different services provided by a plurality of database servers in combination, an agent server is installed for executing a script prepared by combining basic functions of the plurality of database servers. Therefore, no renewal of the functions of the original database servers is required, and thus services of a plurality of sites in combination can be provided quite easily.

Preferably, the plurality of services at least include accepting reservations of a facility and managing schedules of users of the facility.

Preferably, the agent server includes: a site database for storing information related to the basic functions of the plurality of database servers; and a script preparation section for preparing a new script by combining the basic functions of the plurality of database servers with reference to the site database according to a request from the terminal. Accordingly, a combination of services of a plurality of sites according to a request of the user can be easily provided.

According to another aspect of the invention, an agent server in a network system having a database server for providing a predetermined service is provided. The agent server emulates manipulation for the database server in response to a request from a terminal, wherein the agent server includes a script storage section for storing a script prepared by combining basic functions of the database server, and the agent server adds an expanded function to the predetermined service by executing a script stored in the script storage section according to a request from the terminal.

Preferably, the database server accepts reservations of a facility as the predetermined service.

Preferably, the script storage section stores a script for making a provisional reservation.

Preferably, the script storage section stores a script for standby, and the script includes: receiving a standby request from a terminal; monitoring the database server on whether or not a reservation for which the standby request was made becomes void or is canceled; and newly making a reservation with the database server using an account of a user who made the standby request once the reservation becomes void or is canceled.

Preferably, the script storage section stores a script for adjusting schedules of users related to a reservation, and the script includes: receiving a request for schedule adjustment together with a plurality of reservation candidate dates/times and mail addresses of the users from a terminal; making reservations for the reservation candidate dates/times with the database server; preparing a Web page for permitting voting for the reservation candidate dates/times and registering the Web page with a Web server; sending a request for voting on the Web page to the mail addresses of the users; and finalizing a reservation date/time and canceling the other reservation candidate dates/times based on the voting result.

Preferably, the script storage section stores a script for disclosing reservation details to the third party, and the script includes: receiving a reservation request from a terminal; making a reservation with the database server; and registering information on details of the reservation with a bulletin board server.

Alternatively, in a network system having a plurality of database servers for providing services different from each other, the agent server of the present invention emulates manipulation for the plurality of database servers in response to a request received from a terminal, wherein the agent server includes a script storage section for storing a script prepared by combining basic functions of the plurality of database servers, and the agent server provides the plurality of services provided by the plurality of database servers in combination by executing a script stored in the script storage section according to a request from the terminal.

Preferably, the agent server described above further includes: a site database for storing information related to the basic functions of the plurality of database servers; and a script preparation section for preparing a new script by combining the basic functions of the plurality of database servers with reference to the site database, according to a request from the terminal.

Alternatively, in a network system having a database server for providing a predetermined service, the agent server of the present invention emulates manipulation for the database server in response to a request received from a terminal, the agent server including: a script storage section for storing a script prepared by combining basic functions of the database server; a user request reception section for receiving a request from the terminal; a script management section for selecting a script to be executed from scripts in the script storage section according to the request received by the user request reception section; and a script execution section for executing the script selected by the script management section, wherein an expanded function is added to the predetermined service by the execution of the script by the script execution section.

### BRIEF DESCRIPTION OF THE DRAWINGS

FIG. 1 is a view showing the entire configuration of a network system of Embodiment 1 of the present invention.

FIG. 2 is a view functionally showing the system construction of first and second examples in Embodiment 1 of the present invention.

FIG. 3 is a sequence diagram showing the basic operation of a reservation system before function expansion is performed.

FIG. 4 shows an example of a reservation menu screen.

FIG. 5 shows an example of a reservation status check screen.

FIG. 6 shows an example of a user authentication screen.

FIG. 7 shows an example of a reservation screen.

FIG. 8 shows an example of a reservation finalization screen.

FIG. 9 is a sequence diagram showing the operation during execution of a provisional reservation function.

FIG. 10 is a flowchart showing the operation of an agent server during execution of the provisional reservation function.

FIG. 11 shows a reservation menu screen in the first example in Embodiment 1 of the present invention.

FIG. 12 shows a reservation screen in the first example in Embodiment 1 of the present invention.

FIG. 13 shows a reservation style selection screen in the first example in Embodiment 1 of the present invention.

FIG. 14 shows a provisional reservation completion screen in the first example in Embodiment 1 of the present invention.

FIG. 15 shows a provisional reservation finalization screen in the first example in Embodiment 1 of the present invention.

FIG. 16 shows a reservation acceptance screen in the first example in Embodiment 1 of the present invention.

FIG. 17 shows a specific example of a provisional reservation script in Embodiment 1 of the present invention.

FIG. 18 is a sequence diagram showing the operation during execution of a standby function.

FIG. 19 is a view functionally showing the system construction of a third example in Embodiment 1 of the present invention.

FIG. 20 is a sequence diagram showing the operation during execution of a schedule adjustment function.

FIG. 21 shows a notification setting screen in the third example in Embodiment 1 of the present invention.

FIG. 22 shows a mail of voting notification in the third example in Embodiment 1 of the present invention.

FIG. 23 shows a voting screen in the third example in Embodiment 1 of the present invention.

FIG. 24 shows a mail of reservation finalization notification in the third example in Embodiment 1 of the present invention.

FIG. 25 is a view functionally showing the system construction of a fourth example in Embodiment 1 of the present invention.

FIG. 26 is a sequence diagram showing the operation during execution of a function of linking with a bulletin board server.

FIG. 27 shows a bulletin board notification setting screen in the fourth example in Embodiment 1 of the present invention.

FIG. 28 shows a bulletin board screen in the fourth example in Embodiment 1 of the present invention.

FIG. 29 shows a participation screen in the fourth example in Embodiment 1 of the present invention.

FIG. 30 is a view showing the entire configuration of a network system of Embodiment 2 of the present invention.

FIG. 31 is a block diagram functionally showing the inner configuration of a set-top box in FIG. 30.

FIGS. 32A and 32B show examples of screens of a TV set in Embodiment 2 of the present invention.

FIG. 33 is a view showing the entire configuration of a network system of Embodiment 3 of the present invention.

FIG. 34 is a block diagram functionally showing the system configuration of FIG. 33.

FIG. 35 shows an example of data in an account database (DB) in FIG. 33.

FIG. 36 is a sequence diagram showing the operation of the system of Embodiment 3 of the present invention.

FIG. 37 shows a login screen.

FIG. 38 shows a conference room reservation setting screen.

FIG. 39 shows an e-mail notifying completion of a conference room reservation.

FIG. 40 is a view showing the entire configuration of a network system of Embodiment 4 of the present invention.

FIG. 41 is a block diagram functionally showing the system configuration of FIG. 40.

FIG. 42 shows an example of information stored in a site DB in FIG. 41.

FIG. 43 is a sequence diagram showing script registration operation in Embodiment 4 of the present invention.

FIG. 44 shows a menu screen.

FIG. 45 shows a script registration screen.

FIG. 46 is a view showing a specific example of integration of entry items.

FIG. 47 shows a setting screen.

FIG. 48 is a sequence diagram showing the operation of executing a script in Embodiment 4 of the present invention.

FIG. 49 shows an e-mail notifying completion of ticket and hotel reservations.

### DESCRIPTION OF THE PREFERRED EMBODIMENTS

Hereinafter, preferred embodiments of the present invention will be described with reference to the accompanying drawings.

(Embodiment 1)

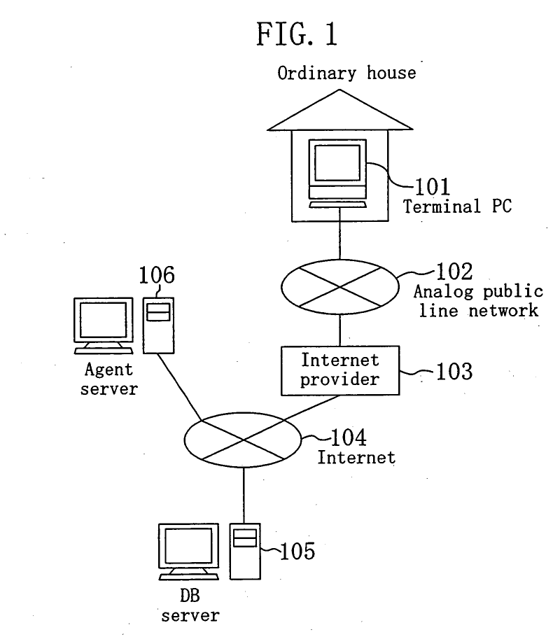

FIG. 1 is a view showing the entire configuration of a network system of Embodiment 1 of the present invention. Referring to FIG. 1, the reference numeral 101 denotes a terminal PC equipped with a modem placed in an ordinary house. An Internet provider 103 receives access from the terminal PC 101 via an analog public line network 102 and secures connection to the Internet 104. A database (DB) server 105 accepts manipulation from the terminal PC 101 and provides a predetermined service. An agent server 106 emulates manipulation for the DB server 105 in response to a request received from the terminal PC 101.

The components 101 to 105 are those generally found in an Internet system. Naturally, other means such as ISDN, ADSL, FTTH and PHS may be used in place of the analog public line network 102 for connection of the terminal PC 101 to the Internet 104.

A feature of this embodiment is that the agent server 106 installed independent of the DB server 105 is connected to the Internet 104, to enable addition of an expanded function to a predetermined service provided by the DB server 105. In this embodiment, assume that the DB server 105 accepts reservations of a facility such as a tennis court as the predetermined service.

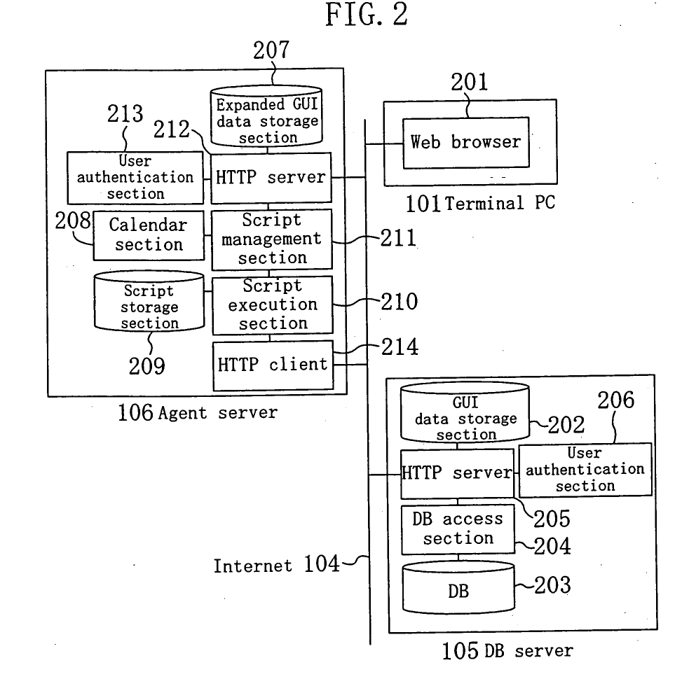

FIG. 2 is a view functionally showing the system configuration of the terminal PC 101, the DB server 105 and the agent server 106 in FIG. 1. As shown in FIG. 2, the terminal PC 101 has a general Web browser 201, which is used as a graphical user interface (GUI) receiving entries from the user.

The DB server 105 includes: a GUI data storage section 202 for storing HTML files of menu screens and entry form screens required for accepting reservations and CGI programs; a DB 203 for managing reservation information; a DB access section 204 for providing a method for manipulating the DB 203, that is, an application program interface (API) to an external system; an HTTP server 205 for performing data transfer from the GUI data storage section 202 and controlling the operation of the DB access section 204, according to a request from the Web browser 201; and a user authentication section 206 for authenticating access to the GUI data storage section 202 and the DB access section 204.

The agent server 106 includes: an expanded GUI data storage section 207 for storing HTML files of menu screens and entry form screens required for use of an expanded function and CGI programs; a calendar section 208 for managing dates/times; a script storage section 209 for storing scripts for providing an expanded function obtained by combining APIs as basic functions available from the DB access section 204; a script execution section 210 for executing a script stored in the script storage section 209; a script management section 211 for receiving an expanded function use request, selecting a script to be executed from the script storage section 209 and monitoring a script start condition to permit the script execution section 210 to execute the script; an HTTP server 212 as a user request reception section for performing data transfer from the expanded GUI data storage section 207 and controlling the script management section 211 according to a request from the Web browser 201; a user authentication section 213 for authenticating access to the expanded GUI data storage section 207 and the script management section 211; and an HTTP client 214 for accessing the HTTP server 205.

The script start condition mentioned above refers to a condition and event serving as a trigger for starting a script, such as a request from the terminal PC 101 to the agent server 106, a date/time condition including expiration, addition/deletion of a record to/from a DB and a condition related to change of an attribute value.

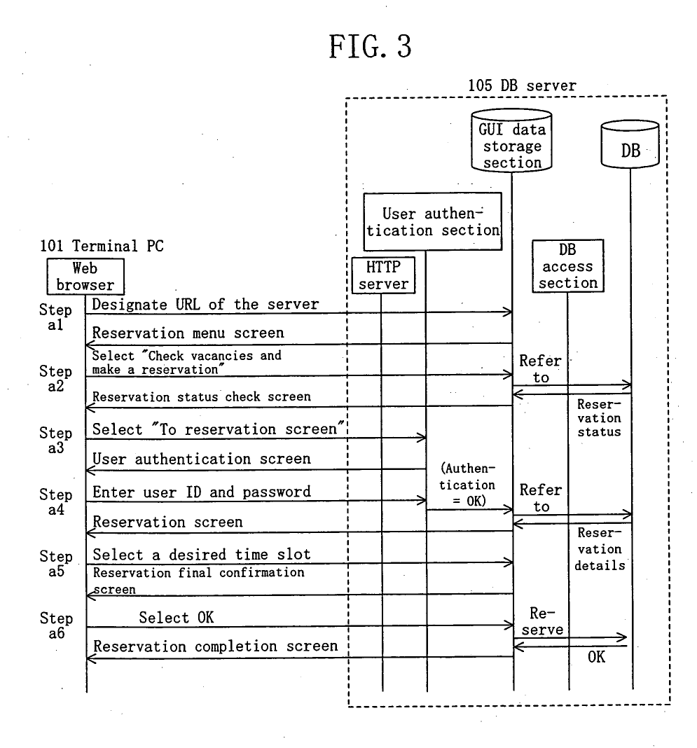

Before discussing the addition of an expanded function by the agent server 106, the basic operation of an original reservation system without function expansion, that is, the reservation system excluding the agent server 106, will be described briefly with reference to a sequence diagram shown in FIG. 3. In the following description, the function of allowing the user to check vacancies of a tennis court and make a new reservation will be taken as an example.

<Step a1>

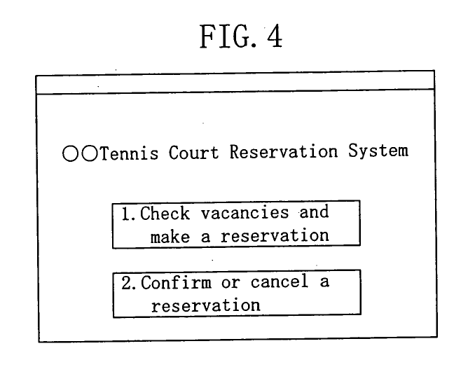

Once the URL of the DB server 105 is designated with the Web browser 210 of the terminal PC 101, the HTTP server 205 retrieves data of a reservation menu screen shown in FIG. 4 from the GUI data storage section 202 and sends the data to the Web browser 201.

<Step a2>

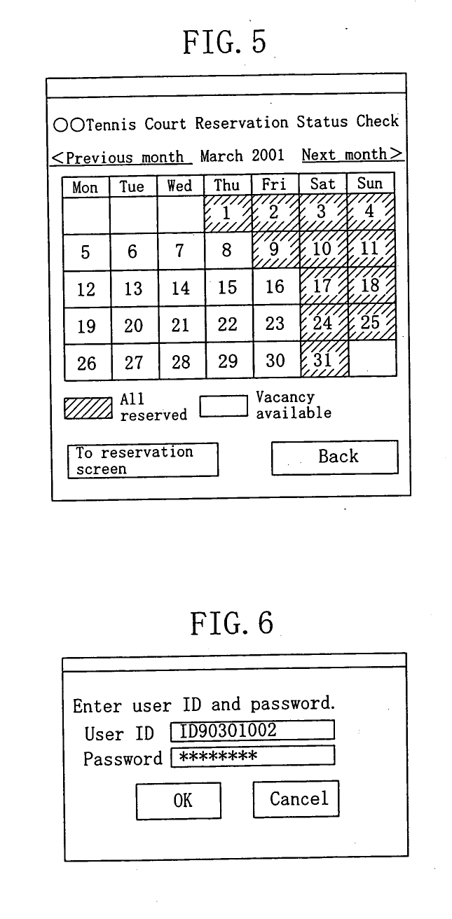

When “Check vacancies and make a reservation” is selected on the reservation menu screen of FIG. 4, the HTTP server 205 executes a CGI program, to refer to the reservation status stored in the DB 203 via the DB access section 204, prepare data of a reservation status check screen shown in FIG. 5 and send the data to the Web browser 201.

<Step a3>

When “To reservation screen” button is clicked on the reservation status check screen of FIG. 5, the user authentication section 206 displays a pop-up screen for user authentication shown in FIG. 6.

<Step a4>

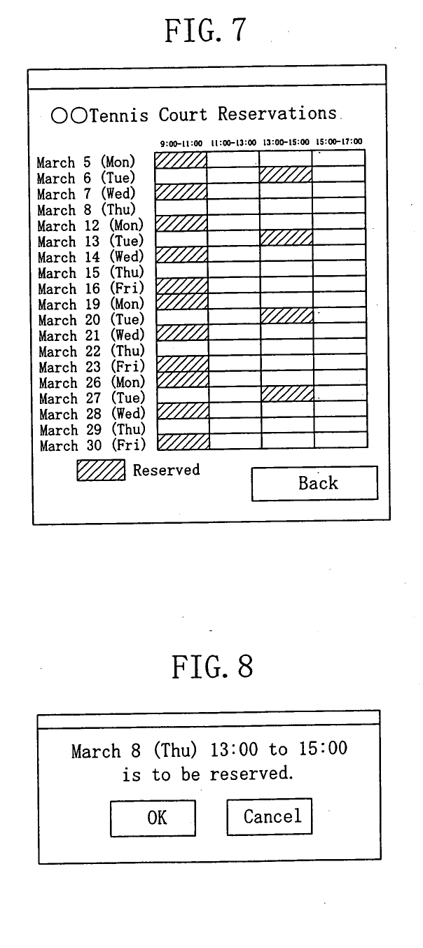

The user ID and password are entered from the Web browser 201. Once the user authentication succeeds in the user authentication section 206, the HTTP server 205 executes a CGI program, to acquire a detailed reservation status from the DB 203 via the DB access section 204, prepare data of a reservation screen shown in FIG. 7 and send the data to the Web browser 201.

<Step a5>

When a desired time slot is selected on the reservation screen of FIG. 7, the HTTP server 205 sends a pop-up screen for final confirmation of the reservation shown in FIG. 8 to the Web browser 201.

<Step a6>

When the user selects “OK” on this screen, the HTTP server 205 executes a CGI program, to perform reservation manipulation for the DB 203 via the DB access section 204 and send a reservation completion screen to the Web browser 201, to complete the reservation procedure.

Hereinafter, some examples of expanded functions that can be added by the agent server 106 will be described. Herein, it is assumed that three basic functions of allowing the user to “make a new reservation”, “check the reservation status” and “cancel a reservation” are provided by the DB server 105. It is also assumed that an account of the agent server 106 is established with the DB server 105 to enable the agent server 106 to manipulate the DB server 105.

### FIRST EXAMPLE

### Addition of Provisional Reservation Function

Suppose a plurality of members use a tennis court. If a reservation is made only after schedules of the members are finally adjusted among the members, all available tennis courts may be booked by others while the adjustment is in process. If it is allowed to make provisional reservations for a plurality of candidate dates and afterwards finalize one from the candidate dates after the adjustment of schedules among the members, such a failure in reserving a tennis court all after success in adjustment of schedules can be avoided. This will therefore be very convenient for users.

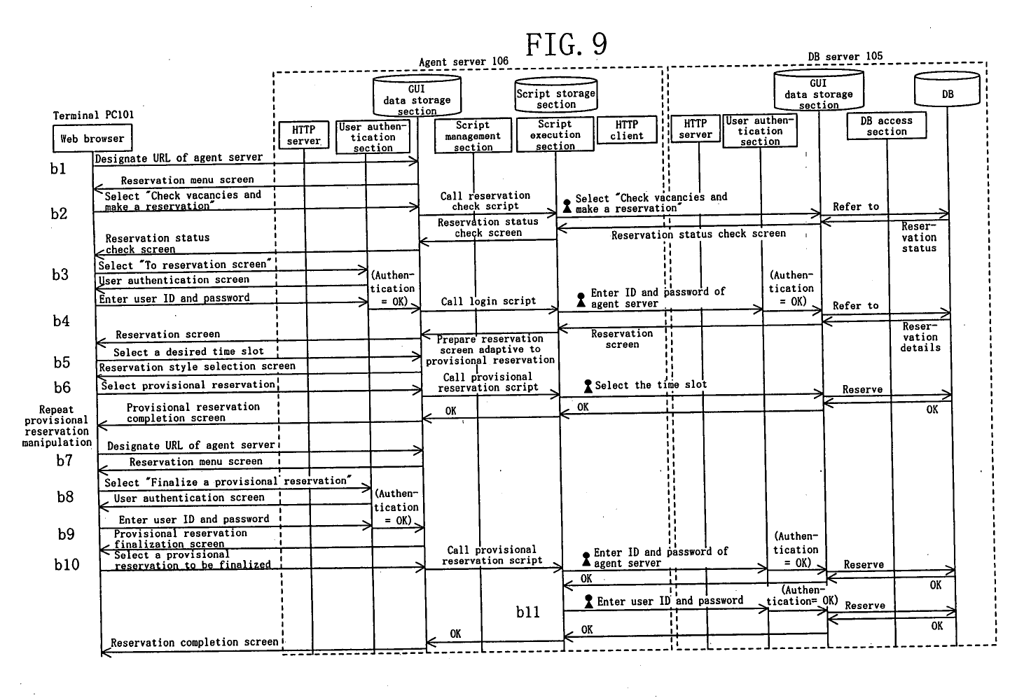

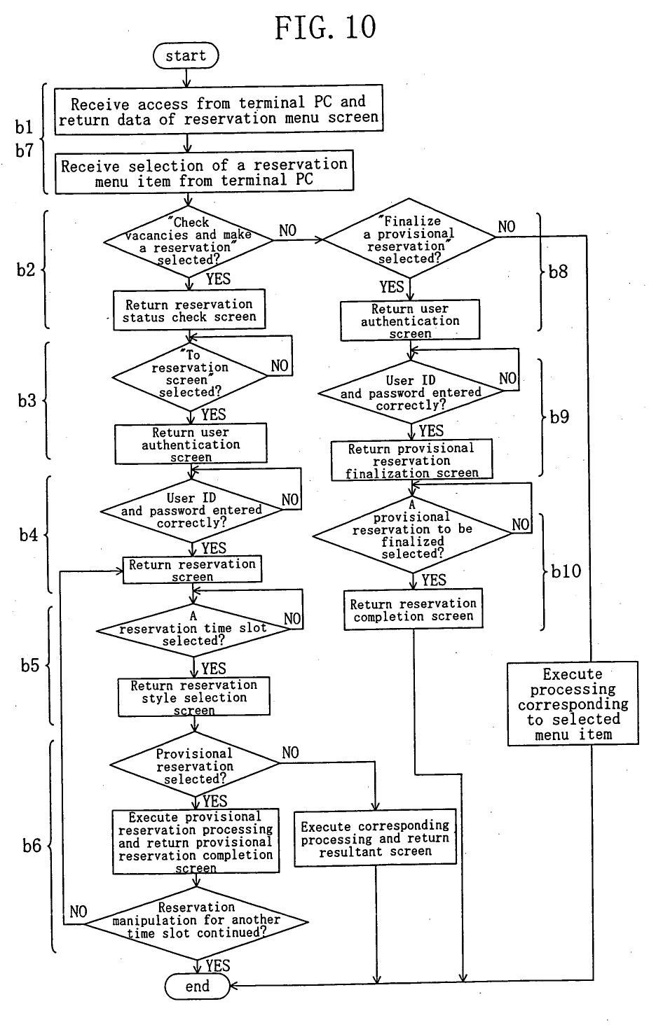

To respond to needs of users as described above, a provisional reservation function is added as an expanded function in this example. FIG. 9 is a sequence diagram showing the operation of the entire system during execution of the provisional reservation function. FIG. 10 is a flowchart showing the operation of the agent server 106 during this sequence.

<Step b1>

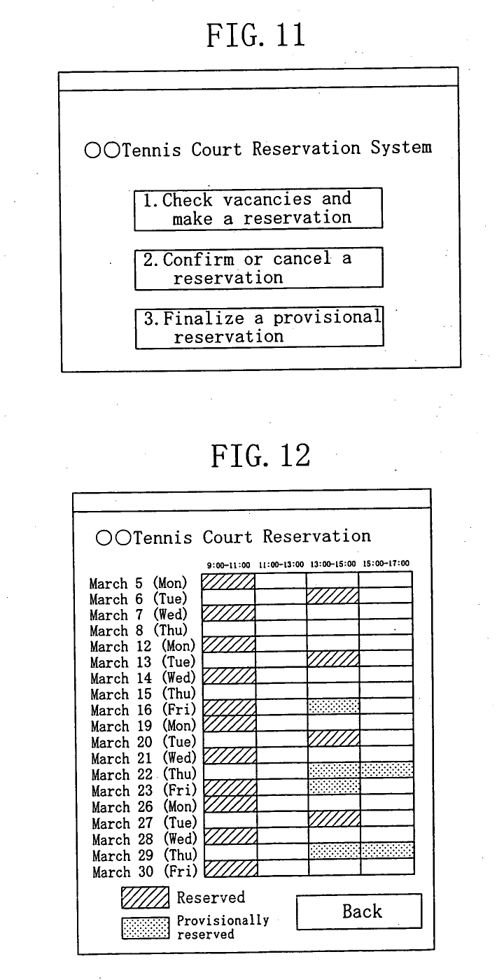

Once the URL of the agent server 106 is designated with the Web browser 201 of the terminal PC 101, the HTTP server 212 of the agent server 106 retrieves data of a reservation menu screen as shown in FIG. 11 from the GUI data storage section 207 and sends the data to the Web browser 201.

<Step b2>

When “Check vacancies and make a reservation” is selected on the reservation menu screen of FIG. 11, the HTTP server 212 executes a CGI program, to instruct the script execution section 210 to execute a “reservation check script”. The reservation check script includes emulating the operation of executing “Check vacancies and make a reservation” that will otherwise be executed directly from the terminal PC 101. That is, the script includes accessing the DB server 105, acquiring data of the reservation status check screen of FIG. 5 and sending the data to the Web browser 201.

<Step b3>

When “To reservation screen” button is selected on the reservation status check screen of FIG. 5, the user authentication section 213 displays the pop-up screen for user authentication of FIG. 6.

<Step b4>

The ID and password of the user are entered from the Web browser 201. Once user authentication succeeds in the user authentication section 213, the HTTP server 212 executes a CGI program, to instruct the script execution section 210 to execute a “login script”. The login script includes emulating the login of the terminal PC 101 to the DB server 105 using the ID and password of the agent server 106. Once user authentication succeeds, the agent server 106 acquires a detailed reservation status from the DB server 105, adds information on provisional reservations managed by the agent server 106 to the acquired information to prepare data of a reservation screen shown in FIG. 12, and sends the data to the Web browser 201.

<Step b5>

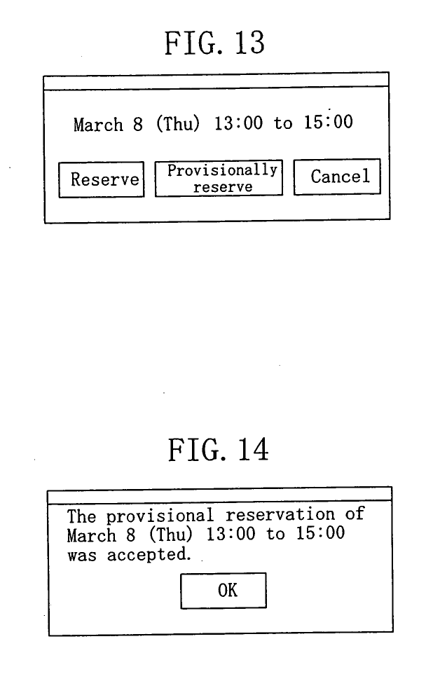

When a time slot is selected on the reservation screen of FIG. 12, the agent server 106 sends a pop-up screen for selection of the reservation style shown in FIG. 13 to the Web browser 201.

<Step b6>

When the user selects “provisionally reserve”, the HTTP server 212 executes a CGI program, to instruct the script execution section 210 to execute provisional reservation registration processing of a “provisional reservation script”. The provisional reservation registration processing includes emulating the operation of “making a reservation” that will otherwise be executed directly from the terminal PC 101. That is, the processing includes making a reservation for the desired time slot selected as a provisional reservation using the ID of the agent server 106, and sending a provisional reservation completion screen shown in FIG. 14 to the Web browser 201. The provisional reservation manipulation in steps b5 and b6 is repeated for other candidate dates. In this example, assume that provisional reservations are made for three dates/times, “March 7 (Wed) 9:00 to 11:00”, “March 8 (Thu) 9:00 to 11:00” and “March 8 (Thu) 13:00 to 15:00”.

<Step b7>

Assume that “March 8 (Thu) 9:00 to 11:00” is finalized after adjustment of schedules among the members. The Web browser 201 accesses the agent server 106 to call the reservation menu screen of FIG. 11.

<Step b8>

When “Finalize a provisional reservation” is selected on the reservation menu screen of FIG. 11, the user authentication section 213 displays the pop-up screen for user authentication of FIG. 6.

<Step b9>

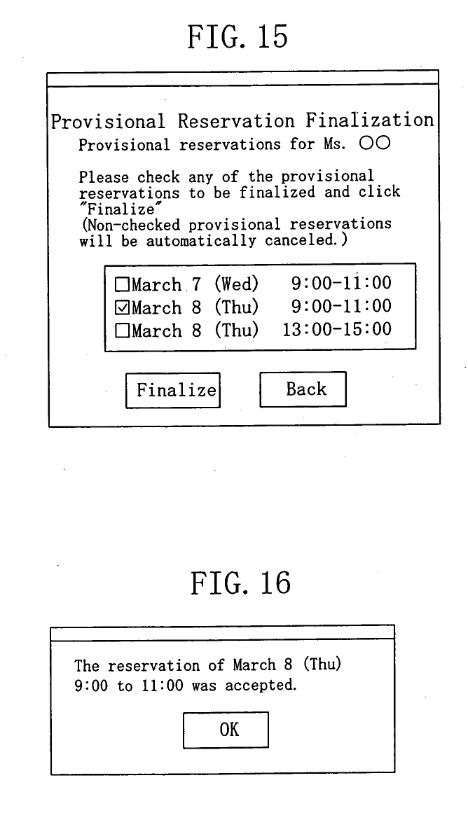

The ID and password of the user are entered from the Web browser 201. Once user authentication succeeds in the user authentication section 213, the HTTP server 212 executes a CGI program, to prepare a provisional reservation finalization screen shown in FIG. 15 and sends the screen to the Web browser 201.

<Step b10>

When “March 8 (Thu) 9:00 to 11:00” is selected and “Finalize” button is clicked on the provisional reservation finalization screen of FIG. 15, the HTTP server 212 executes a CGI program, to instruct the script execution section 210 to execute reservation finalization processing of the “provisional reservation script”. The reservation finalization processing includes first accessing the DB server 105 and canceling all the provisional reservations, “March 7 (Wed) 9:00 to 11:00”, “March 8 (Thu) 9:00 to 11:00” and “March 8 (Thu) 13:00 to 15:00”.

<Step b11>

Subsequently, “March 8 (Thu) 9:00 to 11:00” is reserved using the ID and password of the user. Once the reservation is completed, a reservation acceptance screen shown in FIG. 16 is sent to the Web browser 201, and the series of steps is terminated.

As described above, in this example, the “reservation check script”, the “login script” and the “provisional reservation script” are prepared by combining the three basic functions of allowing the user to “make a new reservation”, “check the reservation status” and “cancel a reservation” of the DB server 105, and are added to the script storage section 209 of the agent server 106. In this way, the provisional reservation function can be easily added to the service provided by the DB server 105.

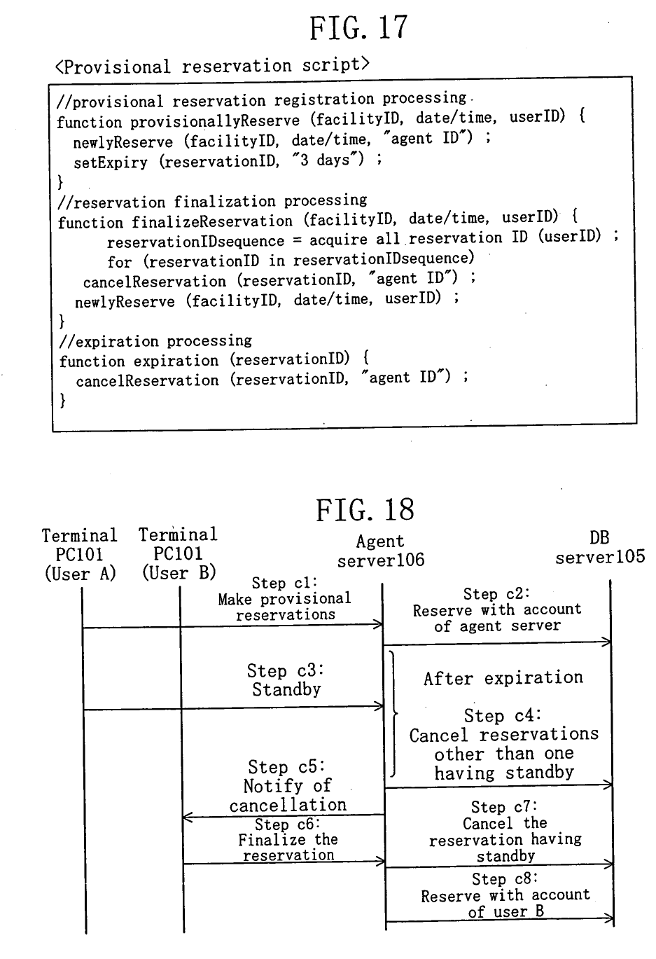

FIG. 17 shows a specific example of the “provisional reservation script”. Although a syntax similar to JavaScript often used for description of Web pages is used in FIG. 17, any other syntax may be used for the scripts.

As is found from FIG. 17, the provisional reservation script is composed of three parts of processing, provisional reservation registration processing, reservation finalization processing and expiration processing. The “provisional reservation registration processing”, which is started upon reception of a request of provisional reservation from the user, makes a reservation of a facility using the ID (account) of the agent server 106 and sets the duration of the provisional reservation at “3 days”. The “reservation finalization processing”, which is started upon reception of a request of reservation finalization from the user, cancels all the provisional reservations made for the user and makes a reservation again for the finalized reservation using the ID (account) of the user. The “expiration processing”, which is started upon passing of a predetermined number of days after the provisional reservation, automatically cancels the relevant reservations. In the example described above, the user finalizes the reservation before the expiration of the provisional reservation. If no action is taken until the expiration of the provisional reservation, the expiration processing of the provisional reservation script is executed, automatically canceling all the provisional reservations.

If the DB server 105 is provided with a function of changing the applicant of a reservation, the “reservation finalization processing” may change the applicant for the finalized reservation and cancel the other provisional reservations, in place of canceling all the provisional reservations. To prevent abuse of provisional reservations, an upper limit may be given to the number of provisional reservations per user (for example, maximum three candidates), and the agent server 106 may manage this upper limit.

To enable the agent server 106 to make a plurality of reservations with the DB server 105, the account of the agent server 106 may be especially allowed to make a plurality of reservations, or a plurality of accounts usable by the agent server 106 may be established.

### SECOND EXAMPLE

### Addition of Standby Function

In the case of providing a provisional reservation function as that described in the first example, it is highly expected that there would be a cancellation after reservation finalization for a time slot for which a provisional reservation has been made. In view of this, an example of adding a function permitting a standby for a time slot for which a provisional reservation has been made will be described with reference to a sequence diagram shown in FIG. 18. Assume in this example that expiration (for example, three days) is set for provisional reservations. The operation in this example is realized by executing a “standby script” stored in the script storage section 209.

<Step c1>

The agent server 106 receives a request for provisional reservations from the terminal PC 101 of user A (corresponding to the steps b1 to b5). Assume in this example that the request is for two provisional reservations of “March 8 (Thu) 9:00 to 11:00” and “March 8 (Thu) 13:00 to 15:00”.

<Step c2>

The agent server 106 accesses the DB server 105 and makes reservations for the above two provisional reservations using the account of the agent server 106 (corresponding to the step b6).

<Step c3>

The agent server 106 receives a request for standby from the terminal PC 101 of user B. Assume in this example that the standby request is for “March 8 (Thu) 13:00 to 15:00”.

<Step c4>

Once the provisional reservations are expired, the agent server 106, considering that the provisional reservations are now void, accesses the DB server 105 and cancels the reservation of “March 8 (Thu) 9:00 to 11:00” having no standby.

<Step c5>

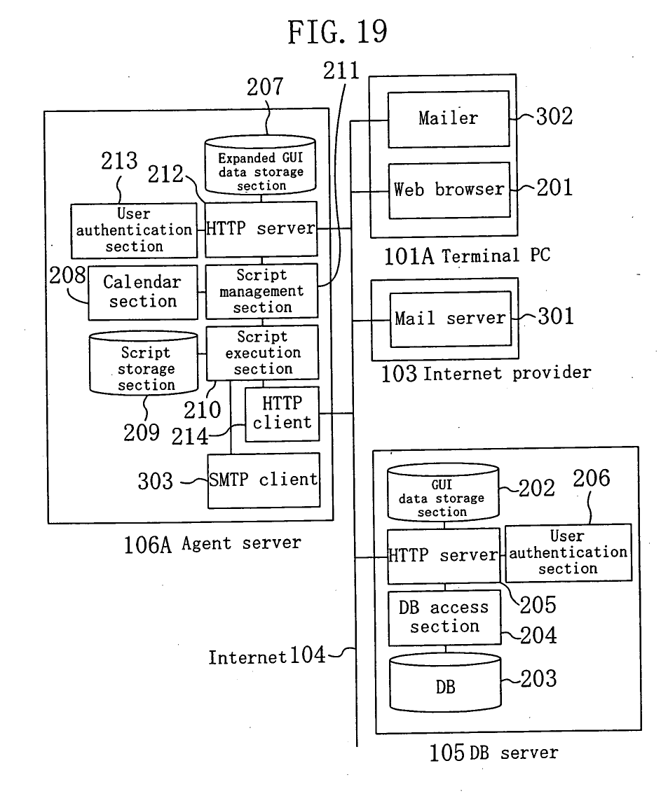

The agent server 106 notifies the user B on standby of the cancellation by e-mail. Notification of the cancellation may be made by other means such as fax and an electronic bulletin board. When an e-mail is used, a system configuration shown in FIG. 19 in the third example to follow may be used.

<Step c6>

The agent server 106 receives a message of reservation finalization from the terminal PC 101 of the user B. The duration of reception of reservation finalization may be determined as 24 hours from the notification of the cancellation, for example.

<Step c7>

The agent server 106 accesses the DB server 105 and temporarily cancels the reservation of “March 8 (Thu) 13:00 to 15:00”.

<Step c8>

The agent server 106 accesses the DB server 105 and makes a reservation of “March 8 (Thu) 13:00 to 15:00” using the account of the user B.

In the case described above, the reservations became void without being finalized before the expiration. If one reservation is finalized before the expiration, the other provisional reservations will be canceled at this finalization. Therefore, the “standby script” may be executed at this time. In other words, whether or not the reservation for which the standby request was made becomes void or whether or not it is canceled may be monitored, and once it become void or is canceled, new reservation manipulation may be executed.

### THIRD EXAMPLE

### Addition of Schedule Adjustment Function

In the case of providing a provisional reservation function as that described in the first example, if schedules of members can be adjusted before the expiration of the provisional reservations, it will be very convenient for the user. In view of this, an example of adding a function permitting users related to a reservation to adjust their schedules as an expanded function will be described.

Specifically, participant users are allowed to vote for provisionally reserved candidate dates/times on a Web screen. In this relation, all participants do not necessarily have their accounts for the DB server 105, and even participants having no account should participate in the voting. Therefore, in this example, the agent server issues temporary user IDs and passwords for each provisional reservation and sends them to listed members by e-mail.

FIG. 19 is a view functionally showing a system construction expanded for this example. In FIG. 19, components used in common with FIG. 2 are denoted by the same reference numerals, and the description thereof is omitted here. Referring to FIG. 19, an Internet provider 103 includes a mail server 301 for providing a function of allocating a mail address to each user and sending/receiving an e-mail to/from the user. A terminal PC 101A includes a mailer 302 for accessing the mail server 301 to prepare, browse and send/receive a mail. The mail server 301 and the Internet provider 103 for one user may be different from those for another user. General mailer software typified by Microsoft Outlook Express may be used as the mailer 302.

An agent server 106A includes an SMTP client 303 for sending a mail according to an instruction from the script execution section 210.

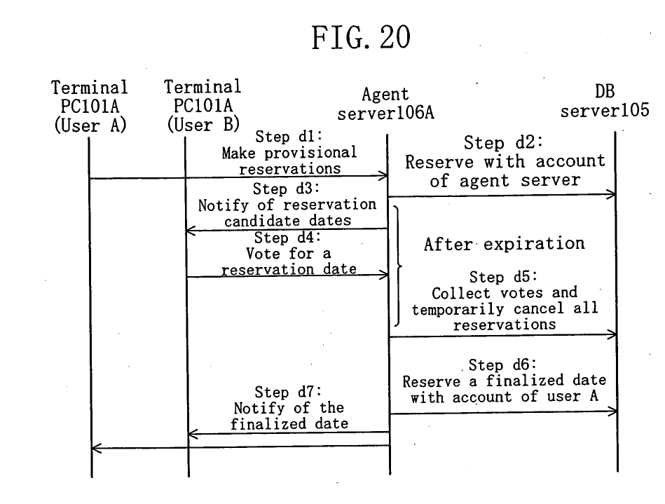

The schedule adjustment function executed by the system of FIG. 19 will be described with reference to a sequence diagram shown in FIG. 20. In FIG. 20, assume that user A makes a provisional reservation, and user B votes for a reservation candidate data/time. Note that the operation in this example is realized by executing a script for schedule adjustment stored in the script storage section 209.

<Step d1>

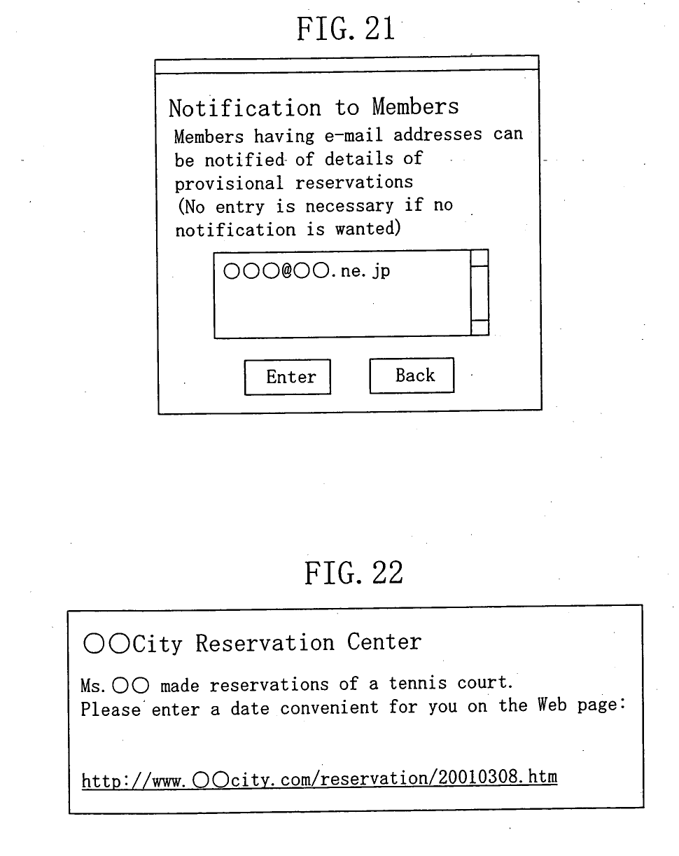

The agent server 106A receives a request for provisional reservations from the terminal PC 101A of the user A (corresponding to the steps b1 to b5). In this example, assume that the request is for three provisional reservations of “March 7 (Wed) 9:00 to 11:00”, “March 8 (Thu) 9:00 to 11:00” and “March 8 (Thu) 13:00 to 15:00”. In this step, also, a screen asking whether or not notification to members should be made, as shown in FIG. 21, is displayed. Assume that the user A enters the mail address of the user B on this screen.

<Step d2>

The agent server 106A accesses the DB server 105 and makes reservations for the above three provisional reservations using the account of the agent server 106A (corresponding to the step b6).

<Step d3>

The script execution section 210 of the agent server 106A executes a “notification to member script” in which members are notified of the provisional reservations by e-mail. Specifically, a mail as shown in FIG. 22 is sent to the user B from the SMTP client 303. The mail of FIG. 22 includes the URL of a Web page on which voting for reservation candidate dates/times is to be performed. This Web page is prepared by the agent server 106A as a temporary page existing only for the voting period for each provisional reservation voting, and is registered with a Web server.

<Step d4>

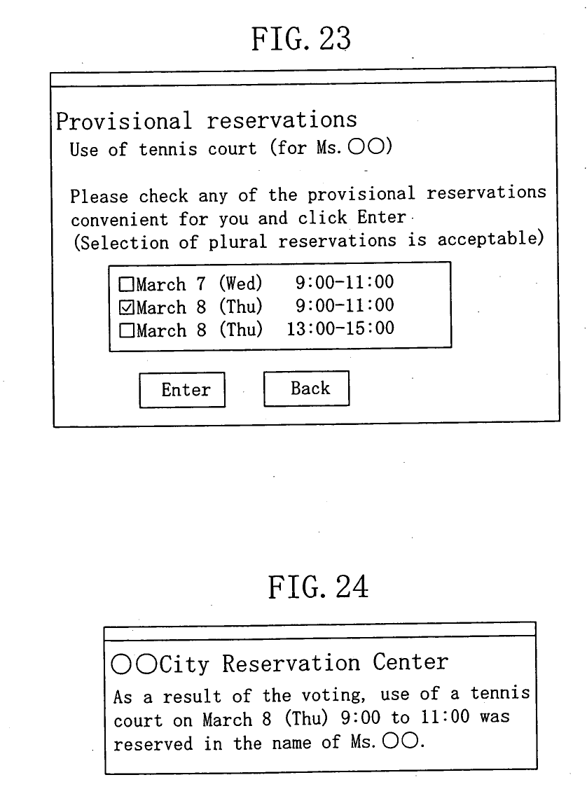

When the user B accesses the URL given in the mail of FIG. 22 with the Web browser 201 of his or her terminal PC 101, a voting page as shown in FIG. 23 is sent from the agent server 106. The user B selects a date/time convenient for his or her schedule among the three candidates. Assume that “March 8 (Thu) 9:00 to 11:00” is selected on the page of FIG. 23.

<Step d5>

The agent server 106A collects the voting result and finalizes “March 8 (Thu) 9:00 to 11:00” selected by the user B as the reservation date/time, and then temporarily cancels all the provisional reservations by executing processing as in the step b10 in the first example.

<Step d6>

By executing processing as in the step b11, “March 8 (Thu) 9:00 to 11:00” is reserved again using the account of the user A.

<Step d7>

The script execution section 210 prepares a message of reservation finalization as shown in FIG. 24, and sends the message to the users A and B via the SMTP client 304 by e-mail. The series of steps is then terminated.

As described above, by providing voting for reservation candidate dates/times on a Web screen, the function of adjusting schedules among users related to a reservation can be added to the reservation system.

In this example, two users, the users A and B, were related to a reservation. A similar voting function can also be provided for three or more users. Also, in voting of a plurality of users, each user may be asked to enter his or her mail address when accessing the voting page.

If a plurality of candidate dates/times won the largest number of votes, voting may be made again for these candidates, or the user who made the reservation may determine one candidate by casting the final vote.

### FOURTH EXAMPLE

### Addition of Function of Linking with Bulletin Board

As mentioned in the third example, at the event of making a reservation of a facility, the user may have a desire of notifying other members or even any persons other than the members of the reservation details. For example, a person may make a reservation of a football ground and simultaneously invite any team to play against, or a person may make a reservation of a conference room to give a seminar and simultaneously invite participants in the seminar.

To respond to the need described above, conventionally, a new function of an electronic bulletin board must be added to an existing system. In this example, however, the agent server 106 adds a function of linking with a bulletin board server as an expanded function.

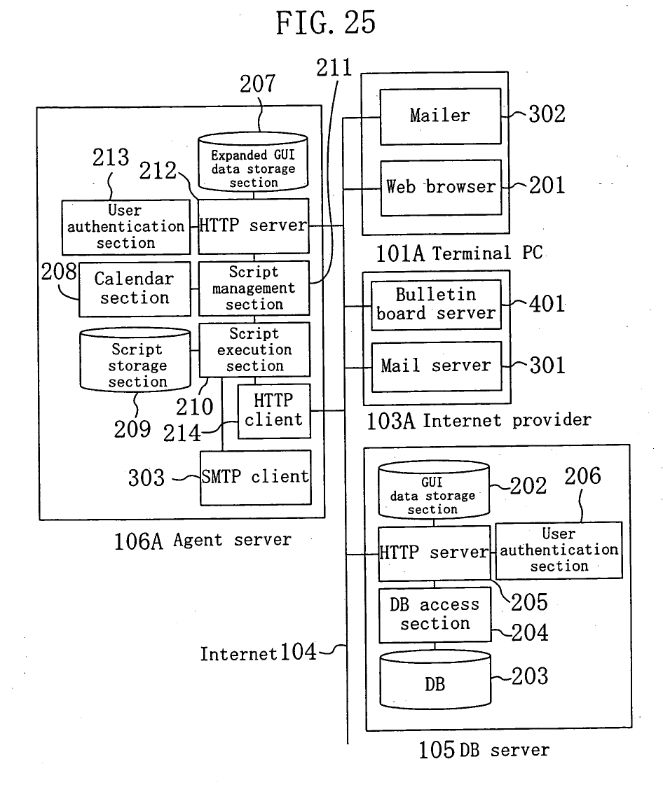

FIG. 25 is a view functionally showing a system construction expanded for this example. In FIG. 25, components used in common with FIGS. 2 and 19 are denoted by the same reference numerals, and the description thereof is omitted here. Referring to FIG. 25, an Internet provider 103A additionally includes a bulletin board server 401 for performing notification on a Web page. Assume that the bulletin board server 401 is provided with a method for enabling external terminals and systems to put information on an electronic bulletin board, and that the script execution section 210 of the agent server 106A can put information on the electronic bulletin board using this method. This facilitates disclosure of reservation details to the third party. The bulletin board server 401 and the mail server 301 may be managed by separate providers or sites.

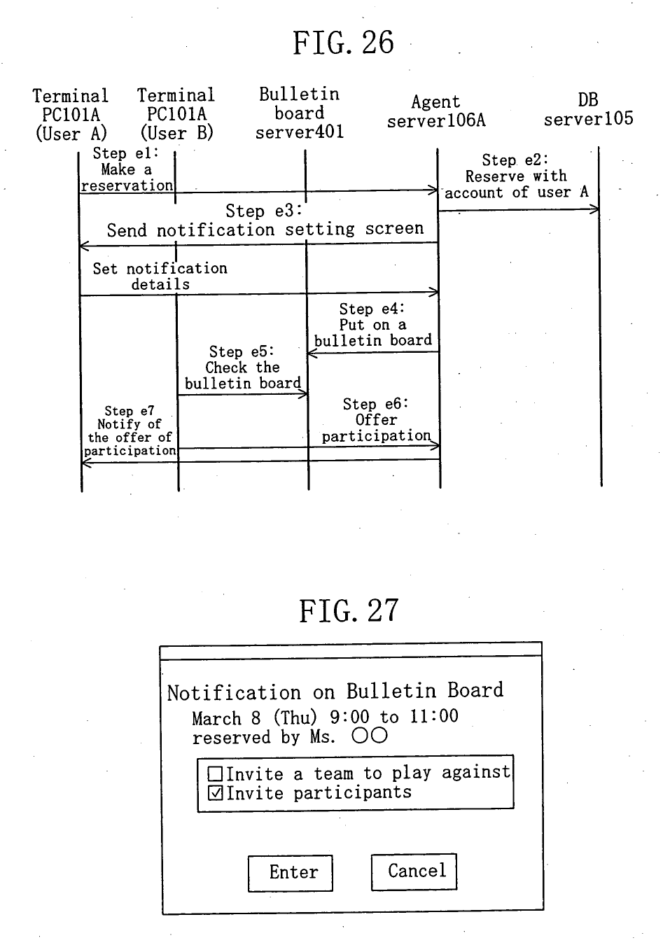

The function of linking with a bulletin board server executed by the system of FIG. 25 will be described with reference to a sequence diagram shown in FIG. 26. Note that the operation in this example is realized by executing a script stored in the script storage section 209.

<Step e1>

The agent server 106A receives a request for making a reservation from the terminal PC 101A of user A (corresponding to the steps a1 to a5).

<Step e2>

The agent server 106A accesses the data server 105 and makes a reservation using the account of the user (corresponding to the step a6).

<Step e3>

Once the reservation is made, the agent server 106A sends a bulletin board notification setting screen as shown in FIG. 27 to the terminal PC 101A of the user A.

<Step e4>

Assume that the user A selects “Invite participants” on the notification setting screen of FIG. 27. The items of notification on the bulletin board can be freely set by the agent server 106A.

<Step e5>

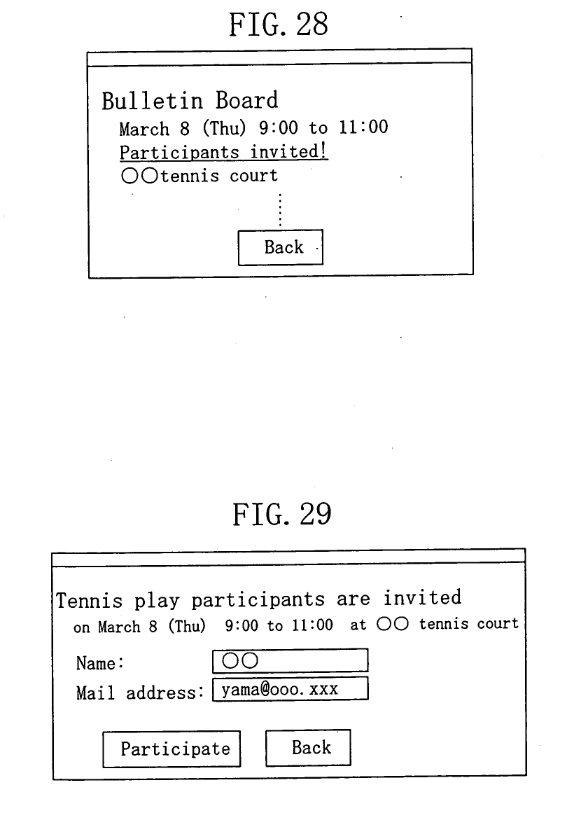

When user B accesses the bulletin board server 401, a bulletin board screen as shown in FIG. 28 is displayed. The part “Participants invited!” has an anchor. By clicking this part, a participation screen as shown in FIG. 29 is displayed. If a bulletin board is open to only specific members, it may be programmed to ask the members to enter their passwords.

<Step e6>

The user B enters his or her name and mail address on the screen of FIG. 29 and selects “Participate” button. The mail address, which is necessary for contact with the participant, may be replaced with other contact means such as a telephone number.

<Step e7>

The agent server 106A notifies the user A of the offer of participation from the user B by e-mail. The series of steps is then terminated.

As described above, by using the agent server 106, function expansion by linking with another existing system such as a bulletin board server can be easily realized.

In this embodiment, the terminal PC was used as the user terminal. It is also possible to use other terminals accessible to Web contents on a network, such as a set-top box (STB) for BS digital broadcasting and an L-mode terminal presented by NTT. An dedicated browser such as a BML browser may be used as a user interface depending on the terminal.

(Embodiment 2)

In the configurations described in Embodiment 1, an expanded function was added to a service provided by a DB server by installing an agent server. In this embodiment, described will be a configuration in which, in a system for providing a service for a specific type of terminal, the service is also made available to another type of terminal by installing an agent server.

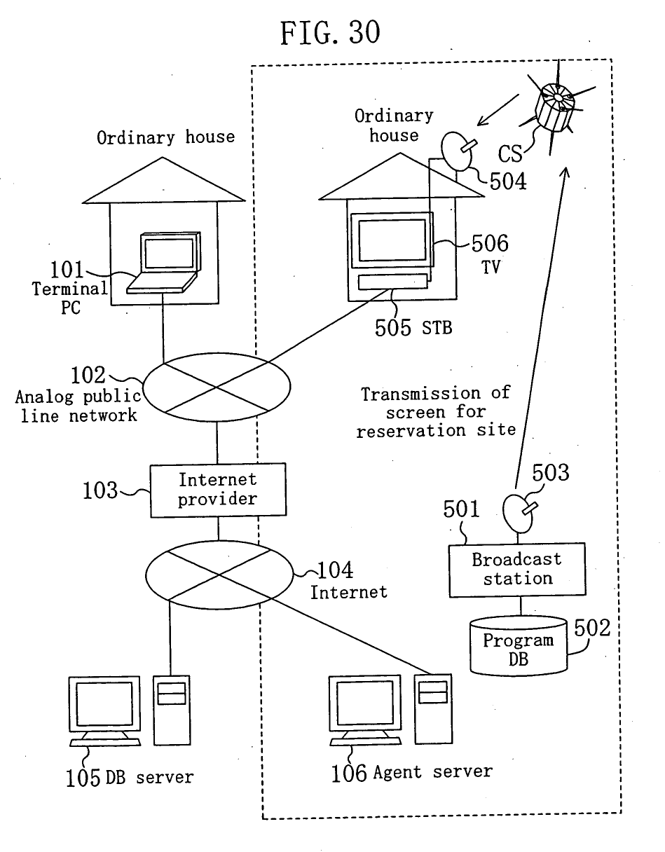

FIG. 30 is a view showing the entire configuration of a network system of Embodiment 2 of the present invention. Components used in common with FIG. 1 are denoted by the same reference numerals. In FIG. 30, the right-side part enclosed with the broken line is a setup added to the original basic system. In the illustrated example, an Internet reservation service using the PC 101 as the first terminal is expanded to a reservation service using a TV set 506 as the second terminal.

Referring to FIG. 30, a broadcast station 501 performs data broadcasting via a communications satellite CS. A program DB 502 stores screen data of broadcast programs. A transmission antenna 503 transmits program data converted to airwaves to the communications satellite CS. A reception antenna 504 receives the airwaves transmitted from the communications satellite CS. A set-top box (STB) 505 recovers the program data from the received airwaves and converts the data to a signal displayable on the TV set 506.

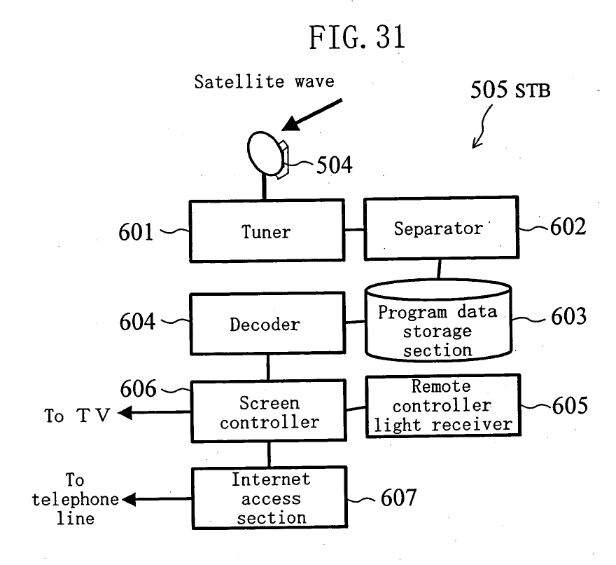

FIG. 31 is a block diagram functionally showing the inner configuration of the STB 505. Referring to FIG. 31, the STB 505 includes: a tuner 601 for receiving/tuning a CS broadcast; a separator 602 for recovering program data from the signal tuned by the tuner 601; a program data storage section 603 for storing the program data recovered by the separator 602; a decoder 604 for decoding coded program data and converting the data to a signal displayable on the TV set; a remote controller light receiver 605; a screen controller 606 for controlling the display screen of the TV set by interpreting a remote controller code received via the remote controller light receiver 605; and an Internet access section 607. The Internet access section 607 accesses a site given by a URL address via the Internet provider 103 when an item selected by the user with the remote controller is associated with the URL address, and interactively acquires screen data necessary for use of a service.

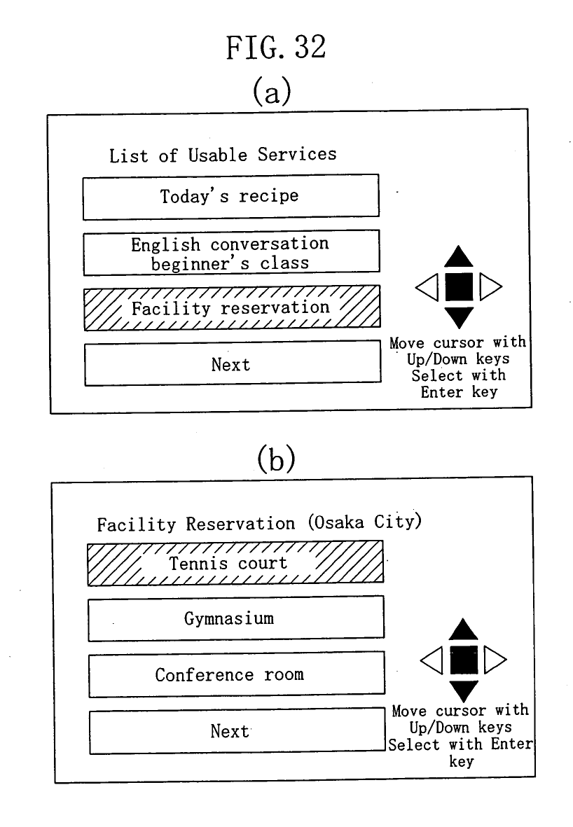

In this embodiment, the broadcast station 501 broadcasts screen data necessary for use of a facility reservation service with the STB 505 via the communication satellite CS. Once a data broadcast button is selected with a remote controller of the STB 505, a service selection screen shown in FIG. 32A is displayed. When “Facility reservation” is selected, a screen shown in FIG. 32B is displayed. The item “Tennis court” on the screen of FIG. 32B is associated with the URL address of the agent server 106. When the user selects “Tennis court”, the screen controller 606 instructs the Internet access section 607 to access the agent server 106. The Internet access section 607 acquires screen data for the STB 505, which corresponds to the screen of FIG. 4, and displays the screen. The screen data for the STB 505 is stored in the expanded GUI data storage section 207 of the agent server 106.

The subsequent operation including making a reservation of a tennis court is emulated by the agent server 106, which is substantially the same as that done using the PC 101 as the terminal described in Embodiment 1. Description thereof is therefore omitted here.

As described above, in this embodiment, in a system for providing a service for a specific type of terminal, the service can be also made available to another type of terminal very easily by installing an agent server without directly changing the original system.

(Embodiment 3)

In Embodiment 3 of the present invention, described will be a configuration in which services of a plurality of sites can be executed in combination according to a request of the user by installing an agent server.

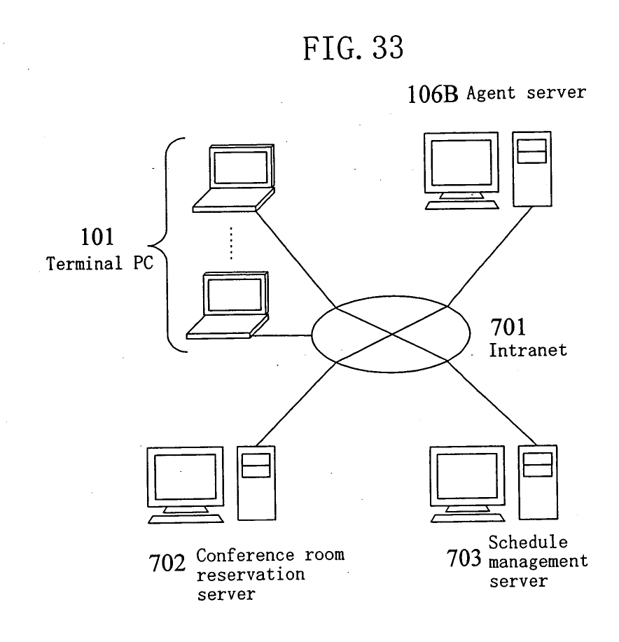

FIG. 33 is a view showing the entire configuration of a network system of Embodiment 3 of the present invention, which is a system realizing a combined service of conference room reservation and schedule management. Referring to FIG. 33, an intranet 701 is established from Ethernet and wireless connection. A conference room reservation server 702 is a DB server for managing the reservation status of a conference room. A schedule management server 703 is a DB server for managing schedules of staff members.

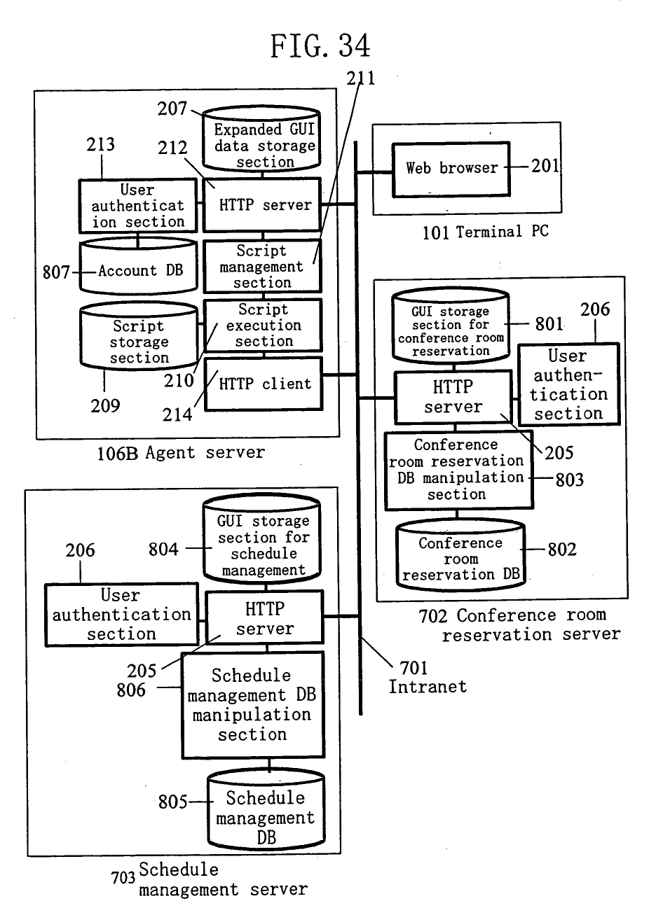

FIG. 34 is a block diagram functionally showing the system configuration of FIG. 33. Referring to FIG. 34, the conference room reservation server 702 includes: a GUI storage section 801 for conference room reservation for storing GUIs displayed on the terminal PC 101; a conference room reservation DB 802 for managing the reservation status of each conference room in a set of the date/time and the ID of a reservation applicant; and a conference room reservation DB manipulation section 803 having an API for permitting the terminal PC 101 to manipulate the conference room reservation DB 802 via the HTTP server 205.

The schedule management server 703 includes: a GUI storage section 804 for schedule management for storing GUIs displayed on the terminal PC 101; a schedule management DB 805 for managing schedules of staff members; and a schedule management DB manipulation section 806 having an API for permitting the terminal PC 101 to manipulate the schedule management DB 805 via the HTTP server 205.

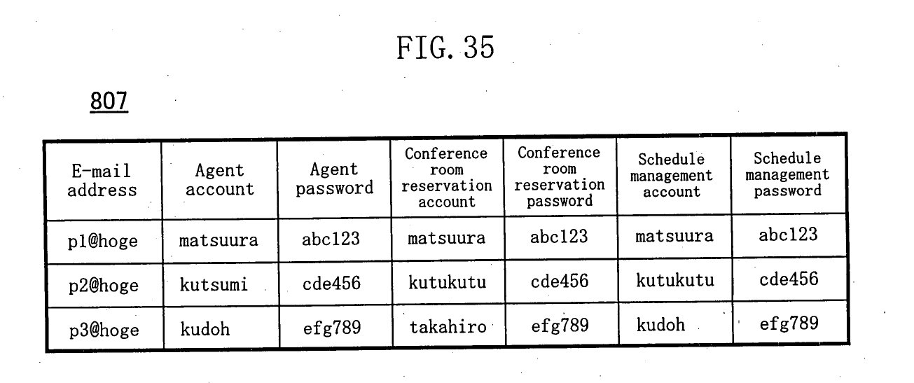

An agent server 106B includes an account DB 807 for storing sets of user IDs and passwords for the agent server 106B, the conference room reservation server 702 and the schedule management server 703 for each staff member. FIG. 35 shows an example of data in the account DB 807. Assume that the account DB 807 is prepared in advance by a system manager.

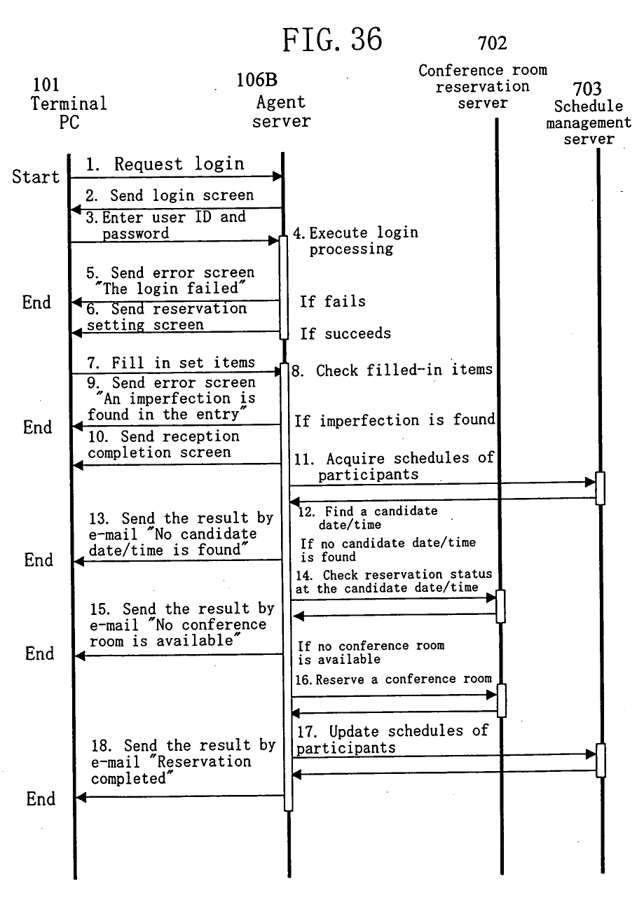

The operation of the system of this embodiment will be described with reference to a sequence diagram shown in FIG. 36. Note that processing in steps 4 to 6 and 8 to 18 is realized by execution of scripts stored in the script storage section 209 by the script execution section 210 of the agent server 106b. In particular, a script for executing the processing in the steps 8 to 18 is a script prepared by combining basic functions of the conference room reservation server 702 and the schedule management server 703.

<Step 1>

The personal PC 101 accesses the URL of the agent server 106B with the Web browser 201 and requests login to the system.

<Step 2>

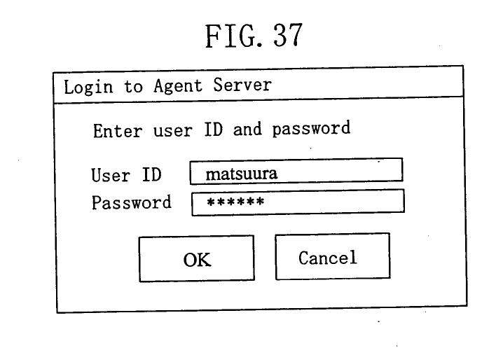

The agent server 106B sends a login screen shown in FIG. 37 to the terminal PC 101.

<Step 3>

The ID and password of the user are entered with the terminal PC 101 and sent to the agent server 106B.

<Steps 4 and 5>

The agent server 106B executes login processing. If the login processing fails due to password error and the like, an error screen displaying that “The login failed” is sent to the terminal PC 101, and the operation is terminated.

<Step 6>

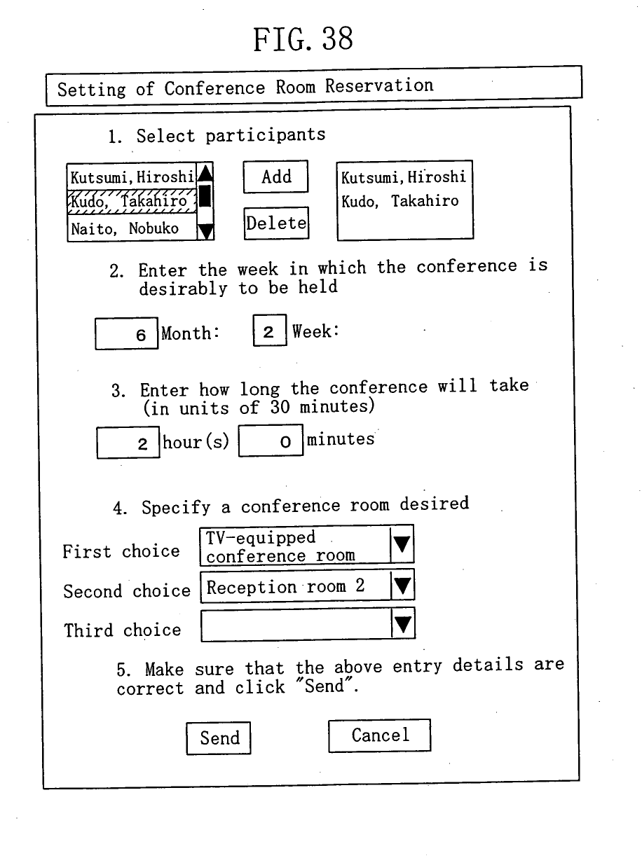

If the login succeeds, a conference room reservation setting screen as shown in FIG. 38 is sent to the terminal PC 101.

<Step 7>

On the conference room reservation setting screen of FIG. 38, the user fills in items such as the names of participants, the week in which the conference is desirably to be held, the time expected to be taken and the desired conference room with the terminal PC 101, and the filled-in form is sent to the agent server 106B.

<Steps 8 and 9>

The agent server 106B checks for any error and omission in the filled-in form sent from the terminal PC 101. If an imperfection is found, an error screen displaying that “An imperfection is found in the entry” is sent to the terminal PC 101, and the operation is terminated.

<Step 10>

If no imperfection is found in the filled-in form, a reception completion screen is sent to the terminal PC 101.

<Step 11>

The agent server 106B accesses the schedule management server 703 and acquires the schedules of all the participants in the designated week.

<Steps 12 and 13>

The agent server 106B compares the acquired schedules with one another to find a date/time in which all the participants are free as a candidate date/time. If no candidate date/time is found, an e-mail notifying that “No candidate date/time is found” is sent to the user who applied for the reservation, and the operation is terminated.

<Steps 14 and 15>

The agent server 106B accesses the conference room reservation server 702 to check the vacancy of the desired conference room for each date/time candidate. If no conference room is available at any candidate date/time, an e-mail notifying that “No conference room is available” is sent to the user who applied for the reservation, and the operation is terminated.

<Step 16>

If a conference room is available, the agent server 106B accesses the conference room reservation server 702 to reserve the conference room. If a conference room is available for a plurality of candidate dates/times, the candidates are narrowed down to one date/time considering the order of precedence and whether or not the date is closer to the application date, for example.

<Step 17>

The agent server 106B accesses the schedule management server 703 and updates the schedules of the participants. For example, information on the date/time for which the reservation has been made is added to the schedules of all the participants.

<Step 18>

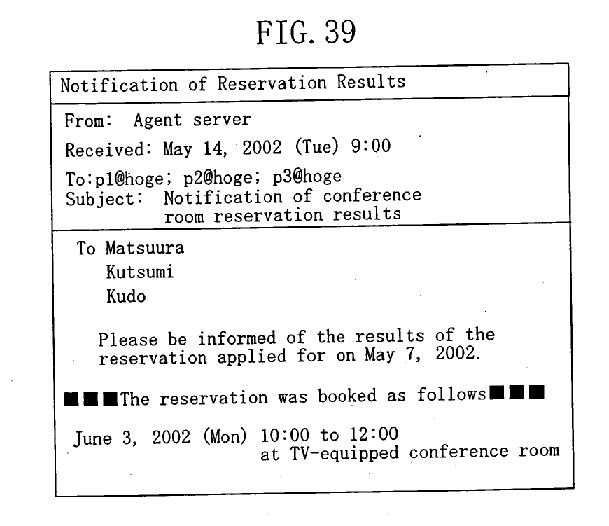

An e-mail shown in FIG. 39 is sent to all the participants, and the series of steps is terminated.

As described above, in this embodiment, services of a plurality of sites can be easily provided in combination by installing an agent server. In this embodiment, reservation of a conference room and management of schedules of staff members were provided in combination. Alternatively, reservation of a facility such as a tennis court and management of schedules of users of the facility may be combined as in this embodiment. Other services can also be easily provided in combination according to the present invention.

(Embodiment 4)

In Embodiment 4 of the present invention, described will be a configuration in which combinations of services of a plurality of sites according to a request of the user can be freely provided by installing an agent server.

Herein, as an example, services of searching a timetable, making arrangements for tickets and making a hotel reservation in combination for a user who is to take an overnight business trip will be described. The agent server receives the URLs of sites to be used for arrangements for an overnight business trip, prepares a script for automatically performing a series of operation of determining a desired arrival time→searching a timetable→determining a train candidate→making arrangements for tickets→making arrangements for a hotel reservation, and by executing this script, emulates the arrangements.

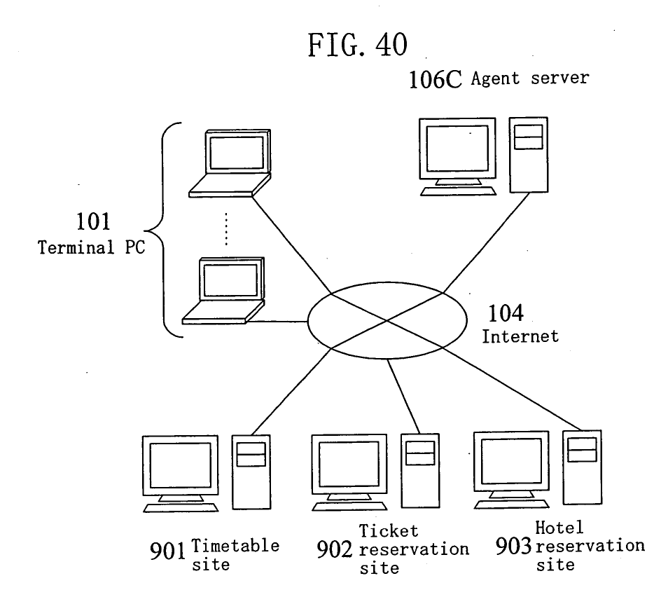

FIG. 40 is a view showing the entire configuration of a network system of Embodiment 4 of the present invention. The system of FIG. 40 includes a timetable site 901, a ticket reservation site 902 and a hotel reservation site 903 as the plurality of DB servers providing services different from one another. The timetable site 901 receives the departure location/destination and the arrival time, and provides candidate trains. The ticket reservation site 902 receives the departure location/destination, the trip date and the train name, and makes arrangements for a ticket. The hotel reservation site 903 receives the stay date and the desired location (place name) to stay, and reserves a hotel room.

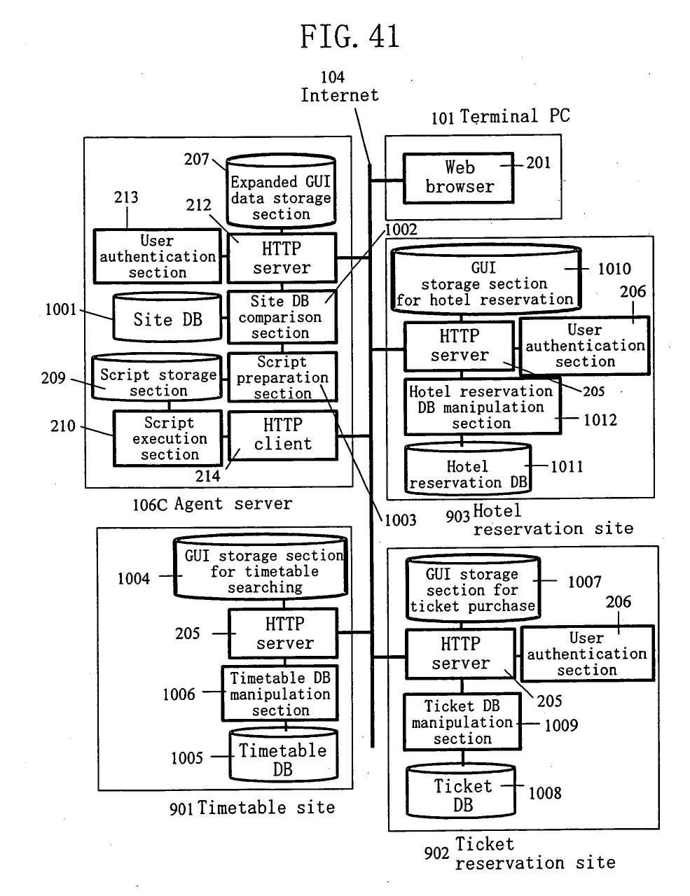

FIG. 41 is a block diagram functionally showing the system configuration of FIG. 40. Referring to FIG. 41, an agent server 106C includes: a site DB 1001 for storing information related to basic functions (for example, the type of API) of the sites 901, 902 and 903 providing services; a site DB comparison section 1002 for integrating entry items from the user by referring to the site DB 1001; and a script preparation section 1003 for preparing a setting screen based on the entry items integrated by the site DB comparison section 1002 and also preparing a new script by combining the APIs provided by the sites 901, 902 and 903.

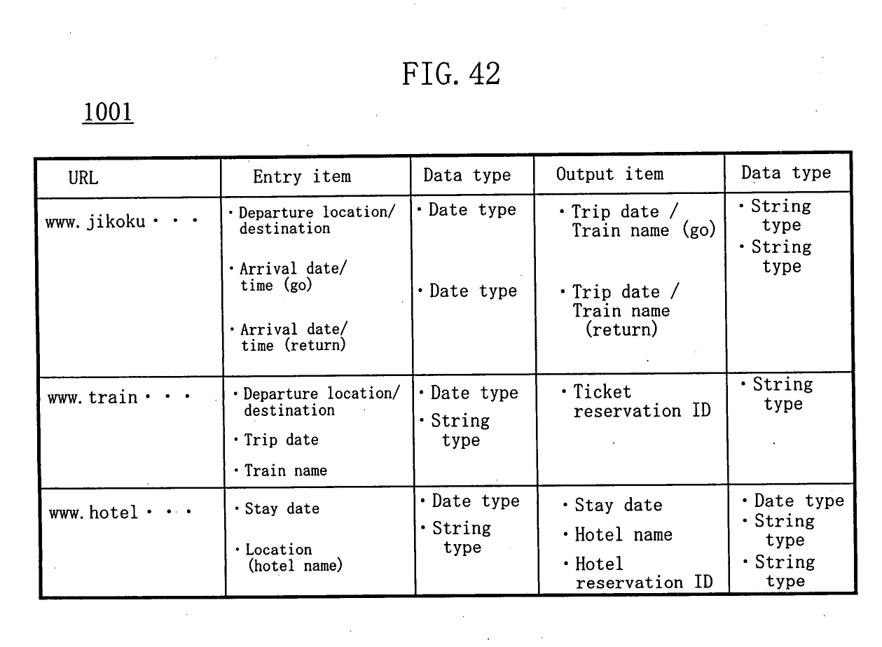

The site DB 1001 stores information on entry items and output items necessary for execution of the APIs. FIG. 42 shows an example of the information stored in the site DB 1001.

The timetable site 901 includes: a GUI storage section 1004 for timetable searching for storing GUIs displayed on the terminal PC 101 when this site is used individually; a timetable DB 1005 for storing a train service schedule for each day; and a timetable DB manipulation section 1006 having an API for permitting the terminal PC 101 to manipulate the timetable DB 1005 via the HTTP server 205. The ticket reservation site 902 includes: a GUI storage section 1007 for ticket purchase for storing GUIs displayed on the terminal PC 101 when this site is used individually; a ticket DB 1008 for storing the train seat reservation status for each day; and a ticket DB manipulation section 1009 having an API for permitting the terminal PC 101 to manipulate the ticket DB 1008 via the HTTP server 205.

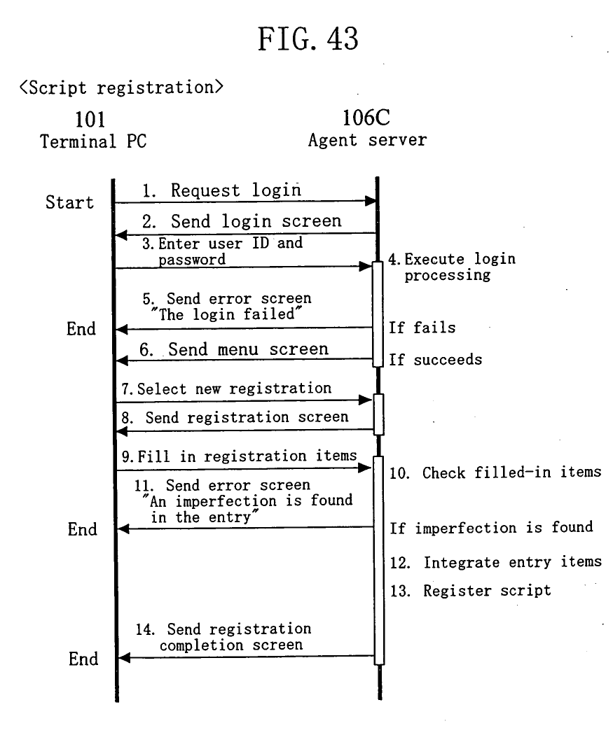

The hotel reservation site 903 includes: a GUI storage section 1010 for hotel reservation for storing GUIs displayed on the terminal PC 101 when this site is used individually; a hotel reservation DB 1011 for storing the vacancies of each hotel for each day; and a hotel reservation DB manipulation section 1012 having an API for permitting the terminal PC 101 to manipulate the hotel reservation DB 1011 via the HTTP server 205. First, script registration operation will be described with reference to a sequence diagram shown in FIG. 43. The login operation in steps 1 to 5 is the same as that in FIG. 36.

<Step 6>

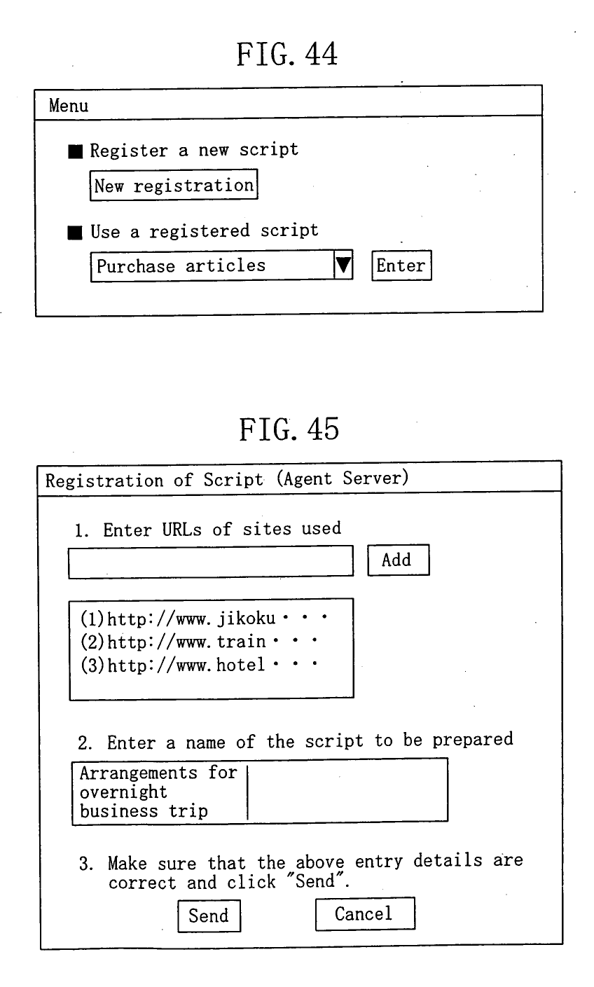

If the login succeeds, a menu screen shown in FIG. 44 is sent to the terminal PC 101.

<Step 7>

On the menu screen of FIG. 44, “New registration” is selected and the result is sent to the agent server 106C.

<Step 8>

The agent server 106C sends a script registration screen shown in FIG. 45 to the terminal PC 101.

<Step 9>

On the script registration screen of FIG. 45, the user fills in items of the registration, and the result is sent to the agent server 106C.

<Steps 10 and 11>

The agent server 106C checks for an imperfection in the filled-in items sent. If an imperfection is found, an error screen displaying that “An imperfection is found in the entry” is sent to the terminal PC 101, and the operation is terminated.

<Step 12>

In the agent server 106C, the entry items and output items of the sites entered are retrieved from the site DB 1001, and the site DB comparison section 1002 integrates the entry items.

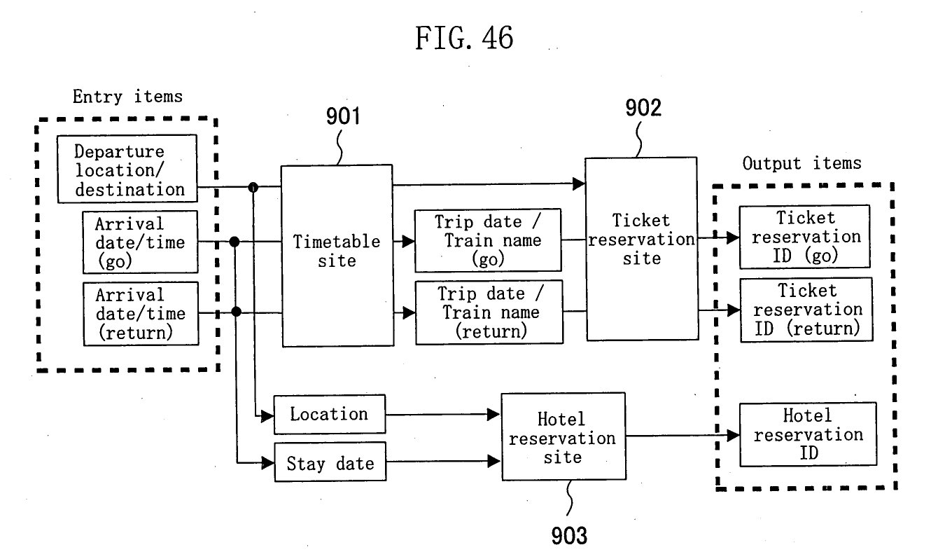

Specifically, the entry items are integrated as shown in FIG. 46. That is, for the timetable site 901 used first, “Departure location/destination”, “Arrival date/time (go)” and “Arrival date/time (return)” are determined as necessary entry items. For the ticket reservation site 902 used next, “Trip date” and “Train name” as the output items of the timetable site 901 are the entry items. For the hotel reservation site 903, one of its entry items, “Location”, can be derived from the entry item “Departure location/destination” of the timetable site 901, and the other entry item, “Stay date”, can be derived from the entry items “Arrival date/time (go)” and “Arrival date/time (return)” of the timetable site 901. Therefore, in the illustrated example, “Departure location/destination”, “Arrival date/time (go)” and “Arrival date/time (return)” are the minimum entry items that should be received from the user.

<Step 13>

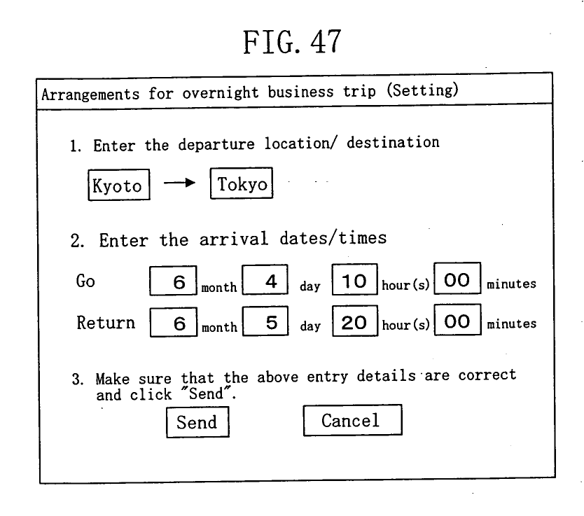

In the agent server 106C, the script preparation section 1003 prepares a setting screen as shown in FIG. 47, and also prepares a new script combining the APIs of the sites 901, 902 and 903, based on the result of the integration by the site DB comparison section 1002. The prepared screen data and script are registered in the script storage section 209 under the title of “Arrangements for overnight business trip”.

<Step 14>

The agent server 106C sends a registration completion screen to the terminal PC 101, and the operation is terminated.

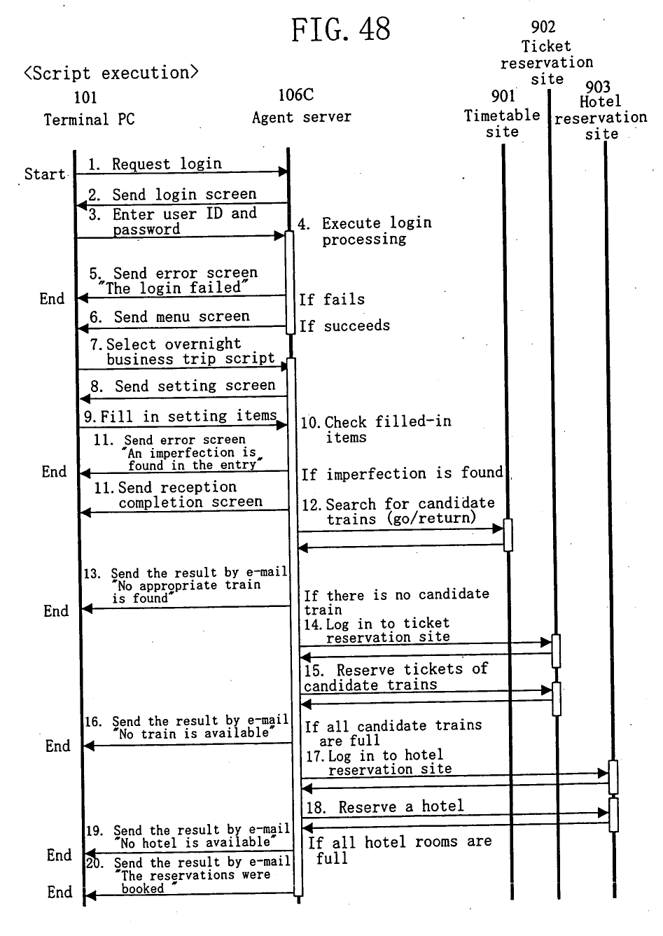

Next, the operation of execution of the script will be described with reference to a sequence diagram shown in FIG. 48. In the following description, assume that the user's account is common among the agent server 106C and the sites 901, 902 and 903, and that an ID and password of the agent server 106C can be used for the ticket and hotel reservations. The login operation in steps 1 to 5 is the same as that in FIG. 36.

<Step 6>

Once the login succeeds, the menu screen of FIG. 44 is sent to the terminal PC 101.

<Step 7>

On the menu screen of FIG. 44, “Arrangements for overnight business trip” is selected from the registered scripts.

<Step 8>

The agent server 106C sends the overnight business trip setting screen of FIG. 47 to the terminal PC 101.

<Step 9>

The user fills in the items of “Departure location/destination” and “Arrival date/time” for go/return, and clicks “Send” button.

<Steps 10 and 11>

The agent server 106C checks for an imperfection in the filled-in items sent. If an imperfection is found, an error screen displaying that “An imperfection is found in the entry” is sent to the terminal PC 101, and the operation is terminated. If no imperfection is found, a reception completion screen is sent to the terminal PC 101.

<Steps 12 and 13>

The API of the timetable DB manipulation section 1006 of the timetable site 901 is executed, to prepare a list of “Trip date” and “Train name” for candidate trains. If there is no candidate train, the agent server 106C sends an e-mail notifying that “No appropriate train is found” to the user who applied for the arrangements, and the operation is terminated.

<Step 14>

The agent server 106C logs in to the ticket reservation site 902 with the account of the user.

<Steps 15 and 16>

The API of the ticket DB manipulation section 1009 of the ticket reservation site 902 is executed, to reserve tickets based on the list prepared in the step 12. When there are a plurality of candidates each for go and return, a train arriving at a time closer to the entered arrival time is given higher priority. If all candidate trains are full, an e-mail notifying that “No train is available” is sent to the user who applied for the arrangements, and the operation is terminated.

<Step 17>

The agent server 106C logs in to the hotel reservation site 903 with the account of the user.

<Steps 18 and 19>

The API of the hotel DB manipulation section 1012 of the hotel reservation site 903 is executed, to search for an appropriate hotel based on “Stay date” and “Location” and reserve a hotel room. If all hotels retrieved are full, an e-mail notifying that “No hotel is available” is sent to the user who applied for the arrangements, and the operation is terminated.

<Step 20>

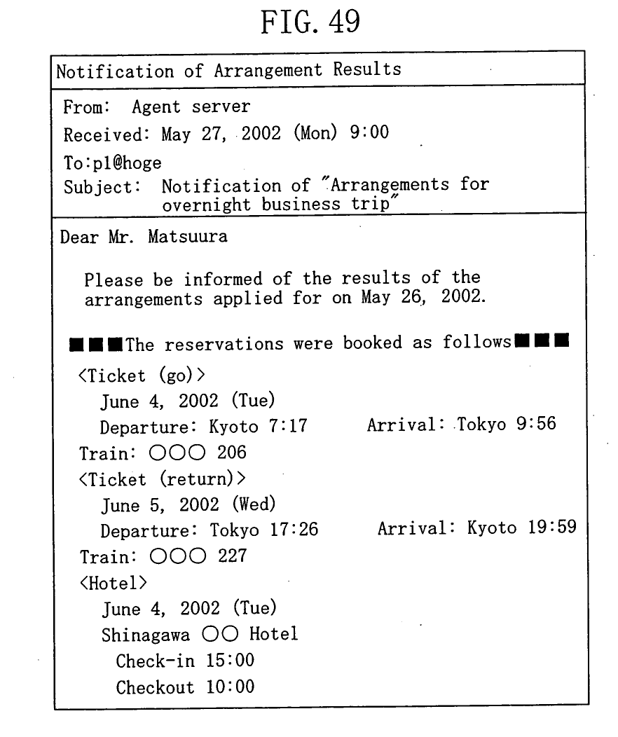

An e-mail message shown in FIG. 49 is sent to the user who applied for the arrangement, and the operation is completed.

As described above, by installing an agent server, it is possible to easily provide a combination of services of a plurality of sites according to a request of the user. In this embodiment, timetable searching, ticket reservation and hotel reservation were provided in combination. Other services can also be easily provided in combination according to the present invention.

Thus, according to the present invention, in a system having a DB server for providing a predetermined service, the function can be easily expanded, without directly changing the original system, by installing an agent server and permitting the agent server to execute combined manipulations for the DB server.

While the present invention has been described in preferred embodiments, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A network system comprising:
a database server for providing a predetermined service; and
an agent server for emulating manipulation for the database server in response to a request received from a terminal,
wherein the agent server comprises a script storage section for storing a script prepared by combining basic functions of the database server, and
the agent server adds an expanded function to the predetermined service by executing a script stored in the script storage section using an account of the agent server for the database server, according to a request from the terminal.

2. The network system of claim 1, wherein the database server accepts reservations of a facility as the predetermined service.

3. (Deleted)

4. (Deleted)

5. A network system comprising:
a plurality of database servers for providing services different from each other; and
an agent server for emulating manipulation for the plurality of database servers in response to a request received from a terminal,
wherein the agent server comprises a script storage section for storing a script prepared by combining basic functions of the plurality of database servers, and
the agent server provides the plurality of services provided by the plurality of database servers in combination by executing a script stored in the script storage section using an account of the agent server for each of the plurality of database servers, according to a request from the terminal.

6. The network system of claim 5, wherein the plurality of services at least include accepting reservations of a facility and managing schedules of users of the facility.

7. The network system of claim 5, wherein the agent server comprises:
a site database for storing information related to the basic functions of the plurality of database servers; and
a script preparation section for preparing a new script by combining the basic functions of the plurality of database servers with reference to the site database according to a request from the terminal.

8. An agent server in a network system having a database server for providing a predetermined service, the agent server emulating manipulation for the database server in response to a request from a terminal,
wherein the agent server comprises a script storage section for storing a script prepared by combining basic functions of the database server, and
the agent server adds an expanded function to the predetermined service by executing a script stored in the script storage section using an account of the agent server for the database server, according to a request from the terminal.

9. The agent server of claim 8, wherein the database server accepts reservations of a facility as the predetermined service.

10. The agent server of claim 9, wherein the script storage section stores a script for making a provisional reservation.

11. The agent server of claim 9, wherein the script storage section stores a script for standby, and
the script includes:
receiving a standby request from a terminal;
monitoring the database server on whether or not a reservation for which the standby request was made becomes void or is canceled; and
newly making a reservation with the database server using an account of a user who made the standby request once the reservation becomes void or is canceled.

12. The agent server of claim 9, wherein the script storage section stores a script for adjusting schedules of users related to a reservation, and
the script includes:
receiving a request for schedule adjustment together with a plurality of reservation candidate dates/times and mail addresses of the users from a terminal;
making reservations for the reservation candidate dates/times with the database server;
preparing a Web page for permitting voting for the reservation candidate dates/times and registering the Web page with a Web server;
sending a request for voting on the Web page to the mail addresses of the users; and
finalizing a reservation date/time and canceling the other reservation candidate dates/times based on the voting result.

13. The agent server of claim 9, wherein the script storage section stores a script for disclosing reservation details to the third party, and
the script includes:
receiving a reservation request from a terminal;
making a reservation with the database server; and
registering information on details of the reservation with a bulletin board server.

14. An agent server in a network system having a plurality of database servers for providing services different from each other, the agent server emulating manipulation for the plurality of database servers in response to a request received from a terminal,
wherein the agent server comprises a script storage section for storing a script prepared by combining basic functions of the plurality of database servers, and
the agent server provides the plurality of services provided by the plurality of database servers in combination by executing a script stored in the script storage section using an account of the agent server for each of the plurality of database servers, according to a request from the terminal.

15. The agent server of claim 14, further comprising:
a site database for storing information related to the basic functions of the plurality of database servers; and
a script preparation section for preparing a new script by combining the basic functions of the plurality of database servers with reference to the site database, according to a request from the terminal.

16. An agent server in a network system having a database server for providing a predetermined service, the agent server emulating manipulation for the database server in response to a request received from a terminal, the agent server comprising:
a script storage section for storing a script prepared by combining basic functions of the database server;
a user request reception section for receiving a request from the terminal;
a script management section for selecting a script to be executed from scripts in the script storage section according to the request received by the user request reception section; and
a script execution section for executing the script selected by the script management section using an account of the agent server for the database server,
wherein an expanded function is added to the predetermined service by the execution of the script by the script execution section.

17. The network system of claim 1, wherein the agent server uses a plurality of accounts for the database server.

18. The agent server of claim 8, wherein the agent server uses a plurality of accounts for the database server.

19. A method for expanding a service in a network system having a database server for providing a predetermined service,
wherein an agent server executes a script for realizing an expanded function of the predetermined service using an account of the agent server for the database server in response to a request received from a terminal, the script being prepared by combining basic functions of the database server.

20. The method of claim 19, wherein the agent server users a plurality of accounts for the database server.

21. A method for expanding a service in a network system having a plurality of database servers for providing services different from each other,
wherein an agent server executes a script for realizing an expanded function of a combination of the plurality of services provided by the plurality of database servers using an account of the agent server for each of the plurality of database servers in response to a request received from a terminal, the script being prepared by combining basic functions of the plurality of database servers.
